(19) United States
(12) Patent Application Publication
(10) Pub. No.: US 2011/0209383 A1
(43) Pub. Date: Sep. 1, 2011

(54) FISHING EQUIPMENT FOR FISHING RODS

(76) Inventor: Patrick TENNYSON, Co. Louth (IE)

(21) Appl. No.: 13/035,306

(22) Filed: Feb. 25, 2011

(30) Foreign Application Priority Data
Feb. 26, 2010 (IE) S2010/0109

(51) Int. Cl. A01K 89/017; A01K 89/033

(52) U.S. Cl. 43/21; 242/250

(57) ABSTRACT

A control system for a fishing line of a fishing rod and a reel with a spool having a fishing line. At least two cooperating dispensing members are arranged about the reel, so that the line emanates from the spool and is positioned between the dispensing members and a cooperating action of the dispensing members dispenses the line. A drag mechanism for providing resistance to dispensing motion of the line is also described. A docking station is provided for the reel. The reel may be specifically adapted to the interchangeable between the fishing rod and the docking station. Also described is a control system which measures the amount of line dispensed or wound in or both and a mechanism for attaching a reel to a rod. A kit for a fishing rod comprising a reel and a docking station is provided.

### FIELD OF THE INVENTION

The present invention relates to fishing equipment for fishing rods. One aspect of the invention relates to a fishing line control system. Other aspects of the invention relate to reel mechanisms. One particular aspect of the present invention relates to a fishing line control device. The present invention further relates to mechanisms for holding the rod and reel and the arrangement thereof. Of particular interest are fishing rods, including fly fishing rods.

### BACKGROUND TO THE INVENTION

Devices for fishing, or fishing rods, have existed for centuries. Conventional fishing rods generally consists of a rod that is handheld to which is fitted a reel, which functions to hold a fishing line. The reel is permanently attached to the rod while fishing. The user or angler holds the rod in one hand. The reel is used to pay out (for example during casting of the line) or reel in the line as appropriate.

In the case of fly-fishing in particular, before or during the cast, the fly line is stripped from the reel by the hand that is not holding the rod. This hand is often termed the “line-hand”. The fly line can be held in large loops in the line-hand but more often than not, this line lies on the ground, or in the water if wading, or at the bottom of a boat. This tends to be because, unlike bait casting where the weight of the bait when cast takes line from the reel due to the weight at the end of the fishing lines, a fly attached to a fly line when cast does not have sufficient momentum to unwind the line from the reel. This necessitates unwinding the line from the reel, as just described, to allow the line to be cast the required distance. When the cast is made the loose line shoots out through the rod rings. During retrieval, the line can again be gathered in loops, for example collected in a figure of eight loop, in the line-hand, but typically the angler lets it drop to the ground or into the water or boat bottom.

A loose line can lead to numerous problems for an angler. For example, the line can get tangled about the feet of the angler, or in scrub or brambles while casting on the river bank, or in the case of wading, tangled around the legs or feet of the angler in the water. If tangles as these occur they can cause problems for the angler. When a fish has been hooked when the line is tangled, the fish often escapes before the line is released from the tangle. A further obstacle facing the angler while playing a fish is the task of getting the loose line quickly wound onto the reel so that the reel drag can be used if the fish runs again. This can be a cumbersome time consuming task, and may have to be performed several times if a fish takes several runs, often allowing the fish to get off if sufficient tension is not maintained in the line. Also when playing a fish all of the pull coming from the fish is acting against the angler's rod arm muscles and can be quite tiring if the pull is great and lasts over a long period.

When an angler is changing bait/lure such as flies, or after casting etc, the rod can be held in either hand, under the arm or placed on the ground or in the boat. During these manoeuvres the rod, line or the reel can be damaged. These actions can also be cumbersome and require a certain amount of agility. For people with disabilities this can prove difficult, as can the reel winding process itself. In order to try and resolve these various issues, fly line baskets and other methods have been developed to hold the fly line during casting and lever operated geared (multiplier) reels have been developed to retrieve the fly line quickly. None of these devices or methods is in common use however.

UK Patent Application No 2394636 describes a fishing line management system for use by an angler. The system as described by this document incorporates a battery power electronically driven fishing reel which is completely separate from the fishing rod. The reel has interchangeable spools mounted on a holster worn by the angler. The reel is electronically powered and operated by a switch mechanism by the angler. The rod and the reel are always apart. Such a system does not allow versatility in the use of the rod. Everything must be done using the powered reel. Furthermore to move the rod away from the angler he must both leave the rod down and remove the reel from his person.

Typically a fishing reel is provided on a mounting bracket which has a reel foot which is attached to the rod. The foot is held in place by a reel seat on the rod which has by two locking rings which encircle the rod. The rod is rotated to visually locate a recess on the reel seat where the reel foot can be inserted. One of the hands then has to be repositioned to attempt to hold both the rod and the reel in its current location while the other hand is used to rotate the reel foot locking ring on the reel seat to a position where the reel foot of the reel is locked into position by the locking ring acting against the reel seat. GB1339229 describes a quick release clamp for clamping a reel to a fishing rod. The reel is held in this instance by an aluminium tube in cooperation with an aluminium ring slide able with respect to the tube. Methods such as the aforementioned can be very cumbersome and time consuming with the possibility of the reel or rod falling onto the ground or into the water during assembly or disassembly resulting in damage or loss. Also good dexterity is needed and thus is particularly difficult for people lacking good dexterity.

The current invention aims to solve the problems associated with currently utilised fishing equipment for fishing lines.

### SUMMARY OF THE INVENTION

The device of the current invention reduces the amount of slack line while fishing, for example fly-fishing, giving the angler more control over the fishing line and in particular fly lines. In addition to imparting ease of use, this also leads to a much more enjoyable experience for the angler. Rapid retrieval and dispensing of the fly line when needed is also possible, for example, when playing a fish, retrieving line for fly changes, moving to a new location, dispensing of fly line for casting, etc. and the line emanating from the spool is kept under constant tension whether the line is been dispensed or retrieved thus reducing tangles on the spool. Drag is also used to control overrun on the reel spool, which can cause line tangles, and also to apply drag to a running fish. Under automatic control, dispensing of the fly line is achieved without assistance from the angler. The fishing rod can also be held in a docking station, which gives the angler freedom in both hands to simultaneously perform whatever other tasks are at hand. The angler no longer experiences fatigue due to the weight of the reel when attached to the rod when fly-fishing as the fishing reel is supported and held on a docking station attached to in this instance the waist of the angler. Less momentum is also produced during the cast thus less power is needed to stop the fly rod to produce the loop needed for a good forward and back cast. If the angler requires, the rod can be reengaged with the reel, the reel disengaged from the docking station and the reel fished as normal. Alternatively using the quick release mechanism different weights resembling different weights of reels can quickly be attached to the rod if this is the desire of the angler. Also the rod or reel can be attached to any object where that object has a matching quick release mechanism installed. The current device is also of benefit to disabled anglers by virtue of its ease of use and the docking station may be attached to for example a wheel chair, boat seat, boat etc. instead of the angler. The quick release mechanism of the current invention allows the angler to lock or detach the reel from the rod is seconds with very little dexterity needed. This can also be achieved even in poor light conditions by feel alone.

According to the first aspect of the present invention there is provided a control system for a fishing line of a fishing rod, the control system comprising

(i) a reel with a spool having a fishing line,
(ii) at least two cooperating dispensing members arranged about the reel.

This arrangement allows for the dispensing members to pull line from the spool while working in cooperation with the spool and dispense it along the rod, for example through eyes provided on the rod and through which the line is dispensed.

The line can thus emanate from the spool and be positioned between the dispensing members such that a cooperating action of the dispensing members dispenses the line. In a preferred embodiment of the present invention rotational cooperating movement between the dispensing members and the spool dispenses the line. The cooperating dispensing members may have a configuration where each dispensing member is rotated for dispensing movement of the line. The dispensing members provide tension in the line between the spool and the dispensing members to pull line from the spool. The dispensing members in cooperation with the spool act to dispense the fishing line. Rapid retrieval and dispensing of a fishing line is possible when needed.

The fishing line can thus be clinched between the dispensing members. Preferably, at least one, and desirably two dispensing members has a pliable surface which allows the line to sink into the pliable surface of the dispensing members to afford traction. The line is thus better gripped and is less likely to stall while being dispensed. For example the pliable surface provides better grip than a non-pliable (hard) surface. It also allows for some degree of slip where not all of the dispensing action from the dispensing members is transmitted to the line so that at least one dispensing member slips on the line while the line is being dispensed. When line is been wound onto the spool resistance of one or more dispensing members to movement, for example rotation, is aided by the pliable nature of the surfaces of the dispensing members interacting with each other and the line. This resistance to rotate causes tension in the fishing line when line is been wound onto the spool by the drive mechanism. Therefore constant line tension is achieved when the line is both been dispensed or retrieved from the spool.

Beneficially, the dispensing members interact with the spool thereby producing line tension between the dispensing members and spool. The dispensing members may interact with the spool through a drive mechanism producing line tension between the dispensing members and spool. Keeping tension in the line is desirable as a loose line will quickly entangle.

In a further embodiment of the present invention the dispensing members additionally have a non-cooperating configuration. Preferably, at least one of the dispensing members can move to a non-cooperating position relative to the other dispensing member. For example in the non-cooperating configuration dispensing and desirably also retrieval of the line may in particular be done manually, for example by pulling line off the spool, while manual winding in may additionally desirably be allowed in such a configuration. This means the rod can be utilised as a normal rod with a manually operated spool and also has a configuration where it is a driven.

In a further embodiment of the present invention powered dispensing and retracting is provided for dispensing and retracting a fishing line from and onto the spool and at least one of the dispensing members is driven for dispensing a fishing line from the spool. In this instance, the dispensing member may have a dispensing speed that substantially matches or is greater than the dispensing speed of the spool thereby creating line tension between the dispensing member and the spool. Preferably, the dispensing member has a dispensing speed faster than the dispensing speed of the line emanating from the spool.

In a preferred embodiment of the present invention a line guide controls the position of line emanating from the spool for the dispensing and retrieval of the line. This means that the line is less likely to become tangled or run off the dispensing member or spool.

Advantageously, the line guide is associated with at least one of the dispensing members. The line guide is associated with the dispensing member for holding the line on the dispensing member. The line guide will keep the fishing line within the limits of the sides of the spool for example between spool rims on opposing sides of the spool. In one embodiment the line guide is associated with a powered dispensing member. In a further embodiment the line guide is associated with a non-powered dispensing member. The line guide may be moveable and may be biased against the dispensing action of the line. The line guide may be biased with respect to a dispensing member. Biasing the line guide ensures that the guide does not snag the line as the guide can move in response to changes in position of the line.

In an additional embodiment of the present invention, the spool is driven for winding in of the line. In one embodiment there is a driven dispensing member, which is preferably driven by a one-way drive system, which drives the dispensing member for dispensing of line. The same motor may be employed to do both actions. Power from the motor may be transmitted to each as desired. In another embodiment two separate motors may be used.

In such an embodiment the one-way drive system may inactivate to allow the dispensing member to be rotated in an opposite direction for winding in of the line. The spool may be driven by a one-way drive system, which drives the spool for winding in of line. Beneficially the one-way drive system inactivates to allow manual winding in of the line on the spool.

The control system of the present invention may comprise a dispensing member, which is driven, and/or a spool, which is driven. Such a control system may further comprise a power unit which can be selectively operated to drive at least one of the dispensing members for dispensing the line or drive rotational motion of the spool to wind in the line. Cooperation between the dispensing members and the spool maintains line tension between said dispensing members and spool. The control system of the invention may thus provide an automatic dispensing and/or retrieval of the fishing line, for example fly line, which may be achieved without assistance from the angler.

In yet another embodiment the control system of the current invention may further comprise a drag mechanism for providing resistance to dispensing rotation of the spool. Drag is used to control overrun on the reel spool (for example where the spool turns faster than the line is being dispensed), which can cause line tangles, and also to apply drag to a running fish.

In an additional embodiment the control system of the current invention may further comprise a drag mechanism providing resistance to dispensing rotation of the spool; for providing resistance to winding in rotation of the spool; or for providing resistance to both dispensing and winding in rotation of the spool. In such an embodiment the drag mechanism may be provided by a frictional drag mechanism acting against rotational motion of the spool.

The drag mechanism may be operational between the spool and a drive mechanism for the spool. This is a simple yet effective arrangement.

In a preferred embodiment the drive mechanism used in combination with the drag mechanism is a one-way drive system. Desirably the drag mechanism may be adjustable for the amount of drag applied. In such an instance wherein the drag mechanism is adjustable, the drag mechanism may control the amount of tension in the line between the spool and the dispensing members.

Desirably the drag mechanism is adjustable by an adjuster which is suitably accessible on opposing sides of the spool. The drag mechanism may be adjustable through rotational movement of a spool axle. This provides a simple yet effective arrangement. Setting the amount of drag may be achieved by rotating the spool axle which has an adjusting knob located on either side of the spool and/or reel. While playing a fish movement of the rod (when the reel is docked in the docking station as will be explained below) keeps the line guide and reel facing in the direction of pull coming from the line and the rod.

This pull on the line also causes a line guide which is biased as set out above, for example, spring loaded in one direction to rotate about an axis of a dispensing member for example a roller keeping the fishing line in contact with a dispensing member at all times and lessening the resistance and wear effect of the line as it travels across the surface of the line guide.

Adjusting the amount of drag with this system also affects the tension on the line between the dispensing members and the spool when the dispensing members are in close proximity to each other.

In a preferred embodiment the control system of the present invention further comprises a docking station for the reel. This is a very advantageous arrangement as it allows for motorised movement of the spool.

A docking station of the invention may comprise a support and a docking receiver on the support into which the reel docks. Desirably the reel is interchangeably attachable to both a fishing rod and the docking station. This allows for ease of conversion between a docked configuration in the docking station and a conventional configuration with the reel on the rod.

In this embodiment it is desirable that a releasable attachment is provided by at least one quick release mechanism. Such a quick release mechanism allows interchangeable attachment to the fishing rod and docking station. There may be two release mechanisms, one may be for releasably attaching the reel to the rod and one may be for releasably attaching the reel to the docking station. The quick release mechanism of the current invention allows the angler to lock or detach the reel from the rod is seconds with very little dexterity needed. This can also be achieved even in poor light conditions and/or by feel alone.

The docking receiver may be adjustable with respect to the support so that when in use the angle of the reel can be adjusted in at least one of a horizontal and vertical plane. The angle of the reel can be adjusted in at least one of a horizontal and vertical plane, for example in a compound angle. This allows the spool and/or rod to be moved to a desired position relative to the angler, for example to face in the direction of pull coming from the line.

When the reel body of the current preferred embodiment is docked in the docking station the control system may be powered for dispensing of the line. When the reel is docked in the docking station the control system is desirably motorised for dispensing the fishing line by a motorised drive. The reel may include a manual winding handle for manual winding of the spool, which is operational when the reel is not docked in the docking station. The manual winding handle may also be operational when the reel is docked in the docking station. The control system may include a drag mechanism. The drag mechanism may be active when the reel is in the docking station and active when not in the docking station.

Where a drive mechanism for the spool is provided it is further desirable that a locking mechanism is provided for preventing rotational movement of the drive mechanism when the reel is not docked in the docking station. This allows for normal manual operation of the spool for example pulling out or manually winding in of line on the spool.

In the control system of the invention it is desirable that at least one dispensing member is provided on the reel and at least one dispensing member is provided on the docking station. The dispensing members may then be arranged for cooperation when the reel is docked in said docking station.

Suitably the reel can rotate circumferentially about its axis while in the docking station to achieve the cooperation. This also allows for ease of engaging the reel with the docking station.

Beneficially the docking station is removably attachable to a body belt to be worn by an angler, preferably to be secured around an angler's waist. The body belt may conveniently hold the docking station, (rechargeable) battery pack and any mechanical and electrical control mechanisms and switches. The fly rod can be attached to the reel in the docking station at any time. This gives the angler freedom in both hands to simultaneously perform whatever other tasks are at hand. The angler no longer experiences fatigue when fishing due to the weight of the reel attached to the rod as in this instance the fishing reel is supported and held on a docking station attached to the waist of the angler. The fly reel can remain docked in the docking station or returned to the rod as desired.

In a further embodiment the control system may further comprise a powered dispensing mechanism for dispensing line and an eccentric winding handle for manual gripping for winding the line onto the spool. The eccentric handle may be of a conventional type, for example a handle that is wound by hand that winds line onto the spool. In a fly-fishing context this involves rotating the spool about its own axis. (In other words the handle of the spool may be stationary and the line is wound onto the spool—both arrangements are within the scope of the present invention). In a fly rod the axis of rotation of the spool is generally substantially perpendicular to a longitudinal axis of the rod. The eccentric winding handle may be arranged so that when powered dispensing, and optionally also winding in, of the line takes place, the eccentric handle does not rotate. The control system may be further arranged so that when powered winding in or dispensing of the line is taking place the eccentric handle does not move. When the handle is gripped and rotated rotation of the spool is activated. When the handle is not gripped the eccentric winding handle may be free to rotate in both winding in and dispensing directions. Such arrangements mean that when the device is being driven by a motor the gripping handle does not turn with winding in and/or dispensing of the line. This is important because if the handle is driven it could cause an injury to the angler and/or become entangled in the line. Furthermore the handle does not rotate when line is pulled from the spool for example by the angler or the pull of a fish.

In a further embodiment of the control system of the present invention may further comprise a line-measuring device or devices. These devices can measure the amount of line dispensed or wound in or both. This allows for an intelligent system that knows how much line has been paid out or taken in. For example a control unit may activate a drive mechanism to have the spool wind in and/or dispense an amount of line based on the measured amount. The present invention thus provides a system which automatically pays out or takes in the required amount of line.

The line-monitoring device or devices and the control unit may be remote from each other and communicate by wireless communication. If required the line itself can be provided with detectable markings spaced apart by a specific length, which allow the amount of line passing a point to be detected. The present invention extends to a fishing line, in particular a fly line, which has applied thereto spaced apart detectable markings which can be detected for determining the amount of line passing a given point during winding in or dispensing of the line.

Activating a switch located on the body belt or the rod handle can change the system over to automatic control where the line is wound in and dispensed automatically, without intervention from the angler. A monitoring sensor mounted on the rod can monitor the line speed and direction. As line is pulled in by the angler or pulled out by the momentum of the cast the sensor monitors the amount and signals the reel, for example by wireless means, to wind in or dispense the same amount from the spool.

Preferably at least one of the dispensing members of the present invention is a roller. The roller may be a freewheeling roller. The fishing line can be held between the dispensing members or rollers. Alternatively, at least one of the dispensing members of the present invention may comprise a flat surface or a belt. One dispensing member may be a roller, which acts against another dispensing member, which may be a flat surface or a belt. Desirably both dispensing members are cooperating rollers.

According to the present invention there is also provided a control system for a fishing line, comprising

(i) a reel with a spool having a fishing line,
(ii) a drive mechanism for dispensing the line from the spool; and
(iii) a drag mechanism positioned between the spool and the drive mechanism for providing resistance to dispensing rotation of the spool.

Preferably, the drag system is adjustable for the amount of drag applied. Preferably, the drag mechanism is provided by a frictional drag mechanism acting against rotational motion of the reel.

The present invention also provides a docking station for the reel of a fishing rod, the docking station comprising a support and a docking receiver on the support into which the reel docks and wherein the reel is interchangeably attachable to both the fishing rod and the docking station. This is a very efficient arrangement for allowing the reel to be interchanged as desired for example for different operational reasons.

Preferably, there is a releasable attachment is provided by at least one quick release mechanism which allows interchangeable attachment to the fishing rod and docking station. This is a simple yet effective arrangement.

There may be two release mechanisms, one release mechanism for releasably attaching the reel to the rod and one release mechanism for releasably attaching the reel to the docking station. The docking receiver may be adjustable with respect to the support so that, when in use, the angle of the reel can be adjusted in at least one of a horizontal and vertical plane. When in use, the angle of the reel can be adjusted in both a horizontal and vertical plane. This is important as it allows the reel to face in a desired direction as required.

When the control mechanism of the current embodiment is docked in the docking station the reel is desirably powered for dispensing of the line. When the reel is docked in the docking station the reel is motorised for dispensing the fishing line by motorised drive from the docking station. For example the spool may be rotated by the power supplied.

As with all aspects of the present invention the docking station of the invention can be combined with all or any of the features described in relation to the present invention.

In one particularly desirable arrangement the docking station of this aspect of the present invention may comprise a reel with a spool having a fishing line, at least two cooperating dispensing members arranged about the reel, wherein the line emanates from the spool and is positioned between the dispensing members such that the action of the dispensing members controls the position of the line with respect to the dispensing members and further comprising a docking station, with one dispensing member on the reel and the other on the docking station and the dispensing members in cooperation when the reel is docked in said docking station. This is a very desirable arrangement where the reel and optionally the rod is held by the docking station.

Suitably the reel has two different docking positions. One position may be where the dispensing members are apart (in a non-cooperating position) and the other may be when the dispensing members are in close proximity (in cooperation with each other). These two configurations mean that there is a first configuration where the rod can be used manually (and as normal) even while docked and a second configuration where dispensing and/or winding in of line can be motorised.

Beneficially the docking station is removably attachable to a body belt to be worn by an angler, preferably secured around the waist. The body belt can hold the fly reel, docking station, rechargeable battery pack and necessary mechanical and electrical control mechanisms and switches. The flexible body belt of the current embodiment may hold a (rechargeable) battery pack and one or more of wiring, switchgear, control box which is electrical/electronic for example with rocker switchgear and wireless control circuitry. A plug in connection may also be provided to connect any required electrical circuit to a power supply, such as an external power supply, to run the system. It may also allow for communication between the electrical control box for the downloading or uploading of information of programmable information. Desirably the system of the invention is programmable and desirably a programmable memory is provided that can be used to program the characteristics of control of the reel system. In another instance all mechanical and electrical control circuitry including the rechargeable battery can be built into the docking station itself.

Suitably all the electrical components whether on the body belt or the docking station or the reel are manufactured to be water tight so as to function even when being wet for example for wading or for fishing in wet weather.

The belt of the present invention may be provided with a back support with foldable seat to be used for comfort when sitting in a boat or on the bank. Pockets may be arranged about the belt to store fly boxes, fly lines, spools or anything that the angler requires. Also brackets to hold the landing net, wading staff or any other necessities required by the angler may be provided. Connections may be present to allow the user to connect to an MP3 (or the like) player, radio, light or any device that requires electrical power to run.

Electrical control of the motorised docking station for dispensing and retrieving line may be achieved by switching on an on/off power switch. A secondary changeover switch can be used to switch between a manually controllable position and an automatic position.

When the manually controllable switch position is chosen the amount of power sent to the motor can be controlled for example by a rocker pot switch optionally situated in a control box on the body belt. The rocker pot switch has a neutral spring loaded off position and when activated in either direction sends electrical power to the motor. The more the switch is rotated in either direction the faster the motor travels. When the switch is let go it returns to the neutral position and power is switched off. A rocker switch may be located on the rod with the same function but controls the motor through a wireless connection to the control box. Power to run this switch and the wireless circuitry may be supplied by a small battery pack located on the rod. When the switch on the rod is activated it overrides the switch on the control box situated on the body belt. Changing the direction of the switch reverses the direction of rotation of the motor.

In a further embodiment of the current invention in an automatic mode the line retrieval and dispensing is automatically controlled, for example when a changeover switch is positioned in a “automatic” position the line retrieval and dispensing is automatically controlled by sensor/s located on the rod monitoring the speed and direction of travel of the line. When line is retrieved or dispensed and passes the sensor/s the reel takes in or dispenses the same amount of line on the spool thus retaining the same amount of line, for example slack line, between the sensor and the reel. Communication between the sensor on the rod and the docking station may be by wireless technology with a transmitter on the rod and a receiver on the docking station or vice versa. The automatic control can be overridden when the manually operated remote control unit is activated thus enabling a change of length of slack line between the sensor/s and the reel. The amount of slack line needed would depend on the circumstances and fishing cast been undertaken.

According to a further aspect of the present invention there is provided a reel for a fishing rod the reel being adapted to be interchangeably attachable to both a fishing rod and a docking station for holding said reel. This is a very convenient reel being adapted to fit to both a docking station and the rod.

According to further aspect of the present invention there is provided a reel for a fishing rod, having an eccentric winding handle for manual gripping for manual winding of the reel, and a powered dispensing mechanism for dispensing a fishing line from the reel, and arranged so that when powered dispensing is taking place the eccentric handle does not move with the reel. The reel may be arranged so that when powered winding in and dispensing of the line is taking place the eccentric handle does not move with the reel. As mentioned previously this is particularly advantageous as it prevents injury or entanglement with the handle.

Another aspect of the present invention provides a control system for a line being dispensed from the spool of a fishing rod comprising a rod, a reel and a spool, the system comprising a sensor, which measures the amount of line dispensed or wound in or both. The control system may comprise a control unit that activates a drive mechanism to rotate the spool to wind in and/or dispense an amount of line based on the measured amount. The line monitoring device and the control unit may be remote from each other and communicate by wireless communication. Activating a switch for example a switch located on the body belt can change the system over to automatic control where the line is wound in and dispensed automatically, without intervention from the angler. As line is pulled in by the angler or pulled out upon casting of the line the sensor monitors the amount and signals the reel by wireless means to wind in or dispense the same amount from the spool.

According to a further aspect of the present invention there is provided a mechanism for attaching a reel to a rod, the mechanism comprising, a reel bracket with a first end for attaching to the rod and a second end for attaching to the reel, characterised in that a quick-release mechanism for releasably securing the reel to the bracket is provided to releasably secure the reel to the second end of the bracket. This is a simple mechanism that allows for ease of removal of a reel from a rod and optionally further for attaching the reel to other objects such as a docking station. The bracket may have, at the first end thereof, an elongate foot for engagement by one or more securing rings on the rod. This is a simple arrangement with will allow retrofitting of the mechanism to existing rods. The quick release mechanism may include two cooperating portions one on the bracket and the other on the reel. The quick release mechanism may include a biased latch which automatically secures the reel to the bracket when the two cooperating portions are mated. This allows for a ready attachment of the reel to the rod. The two co-operating portions may mate by inserting a first end of one into the other and then using rotating action to engage the mechanism.

In one embodiment respective ends of the cooperating portions comprise a curved receiver and a pivot pin, the pivot pin for insertion into and engagement with the curved receiver. The pivot pin and the curved receiver are adapted to cooperate with a biased latch so that when the pivot pin is inserted in the receiver first respective ends of the cooperating portions are engaged and when the pivot pin is rotated for mating thereof the biased latch automatically engages second respective ends of the cooperating portions. This allows for ease of attachment.

A further aspect of the present invention provides a kit for a fishing rod, the kit comprising, a reel, a docking station for the reel, and optionally further at least one quick release mechanism which is operable to releasably attach the reel to the rod and the reel to the docking station.

The invention extends to a reel, a control system, a docking station, a drag mechanism and an attachment mechanism for a reel as described herein with reference to and as illustrated in the accompanying drawings.

### BRIEF DESCRIPTION OF THE DRAWINGS

The invention will be more clearly understood from the following description of an embodiment thereof, given by way of example only, with reference to the accompanying drawings, in which:

FIG. 1 is a perspective view of a control system of the current invention for a fishing line and including a reel of the present invention with a spool for a fishing line, and dispensing members arranged about the reel and a (fly) rod held by a docking station of the present invention.

FIG. 2 is an exploded view of the control system of FIG. 1 and including a reel of the present invention with a spool for a fishing line, and dispensing members arranged about the reel.

FIG. 3 is a front part-sectional view which illustrates a locking mechanism for preventing rotational movement of a drive mechanism for the spool comprising a latch engaging in teeth of a spool gear to stop rotation.

FIG. 4 shows a side part-sectional view of an eccentric winding handle for manual gripping for winding the line onto the spool, wherein when the handle is not gripped the eccentric winding handle is free to rotate in both winding in and dispensing directions.

FIG. 5 is an exploded view of the docking station of the invention shown in FIG. 1.

FIGS. 6 to 11 show side views of a series of configurations which illustrate how the reel of the invention may be engaged within the docking station of FIG. 1.

FIG. 12-14 shows partial side views which are also partially sectional view illustrating a series of relative positions of the reel to the docking station including illustrating how the reel can be rotated relative to the docking station to achieve different cooperating positions.

FIG. 15(a-c) show perspective views of the control system of the present invention and various configurations provided by the present invention of it (and a rod) with a docking station which is attached to the angler by a flexible body belt.

FIG. 16 is an exploded view of the docking station illustrating a mechanism for adjusting the angle of the reel relative to an angler while still within the docking station.

FIG. 17 shows (a) a front perspective view and (b) a rear perspective view of the reel of the present invention which is interchangeably attachable to a fishing rod and a docking station.

FIG. 18 shows an enlarged perspective view a quick release mechanism for attaching the reel to a fishing rod.

FIG. 19 shows an exploded perspective view of the quick release mechanism of FIG. 18.

FIG. 20 shows an enlarged perspective view of a latch forming part of the quick release mechanism of FIG. 18.

FIG. 21 shows a perspective view of an alternative quick release mechanism to that shown in FIG. 18.

FIG. 22 shows a side view (and in inset an enlarged partial view in part-section) of the quick release mechanism of FIG. 21.

FIG. 23 shows an enlarged side view of the quick release mechanism as shown in FIG. 18.

### DETAILED DESCRIPTION OF THE DRAWINGS

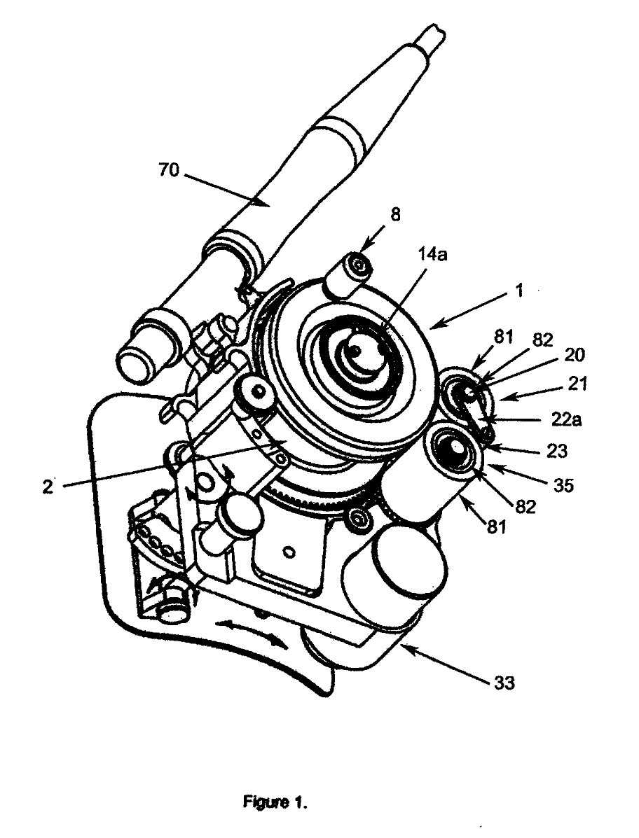

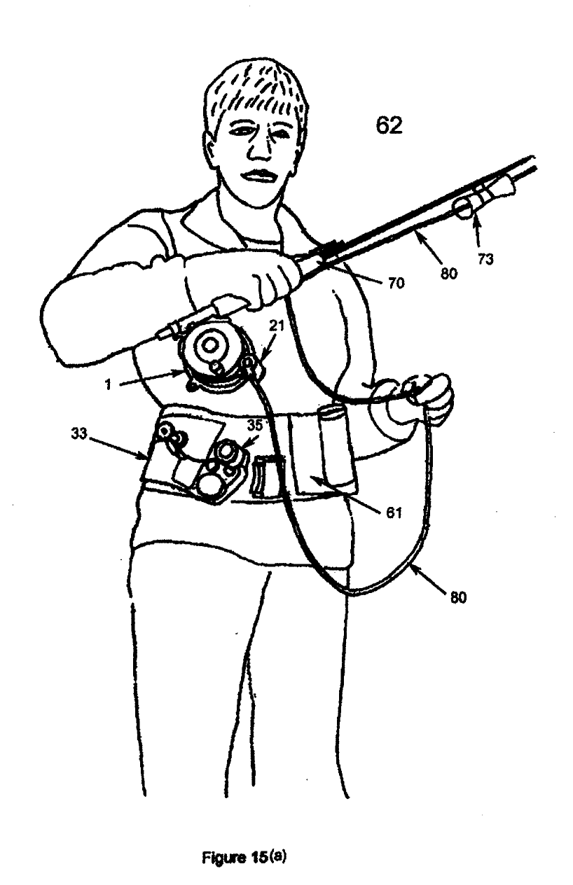

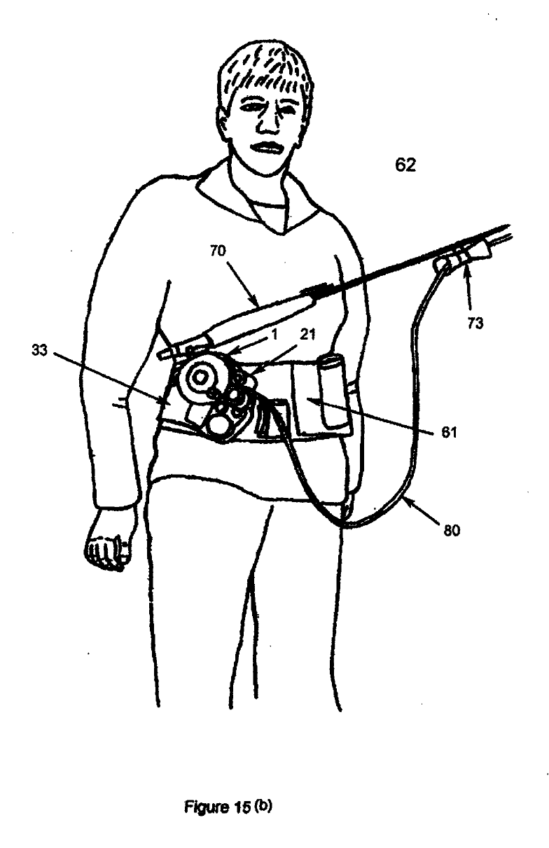

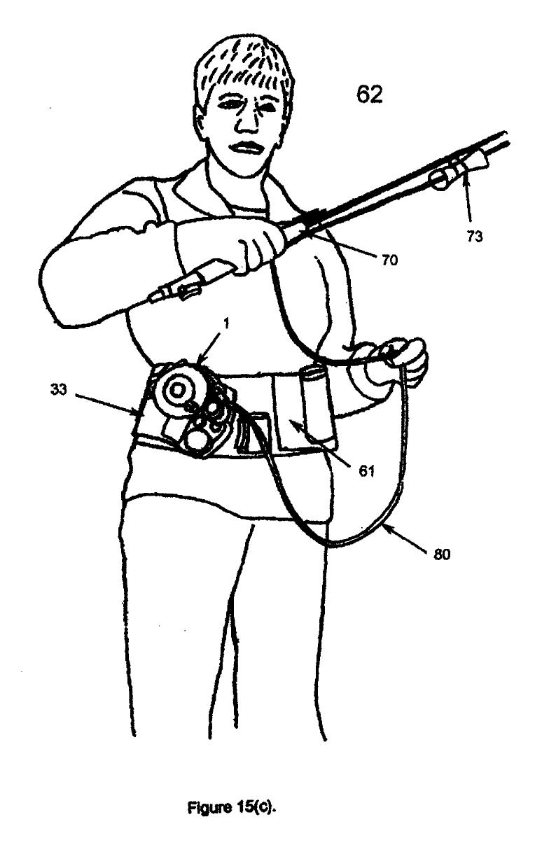

FIG. 1 illustrates one embodiment of a control system for a fishing line in accordance with the present invention. The system of the invention comprises a reel 1 of the invention with a spool 2 for accommodating a line 80 (see FIG. 15) and has two cooperating dispensing members in the form of rollers 21, 35 arranged about the reel 1. In the embodiment a fishing rod 70 is attached to reel 1 which in turn is docked in a docking station 33 of the invention.

The line 80 emanates from the spool 2 and runs between the rollers 21, 35. The line is acted upon by the rollers 21, 35 for the purpose of dispensing and to aid in the retrieval of said line 80. Rotational cooperating movement of the rollers 21, 35 acts to dispense and also aid in retrieval of the line as will be described in more detail below. In this embodiment and when in use, each roller 21, 35 rotates to dispense and aid in retrieval of line 80. The action of the rollers 21, 35 controls the position of the line with respect to the rollers 21, 35.

In the embodiment the dispensing members, rollers 21, 35 each comprise a pliable dispensing surface. In the embodiment there is a cylindrical pliable material in the form of a pliable band 81 mounted a roller hub 82 on each roller. The pliable surface of the rollers 21, 35 causes the line to clinch between the rollers 21, 35 to afford traction. The pliable surface also allows for a degree of slippage while still exerting force on the line. This is important as this allows the force of the rollers 21, 35 to be exerted on the line even if the line is moving more slowly than the dispensing speed of the rollers. The rollers will slip across the line but still continue to rotate to pay out the line. As will be seen from the embodiments below one roller (roller 21) is connected to and thus travels with the reel while the other roller (roller 35) is arranged on the docking station 33 as described below.

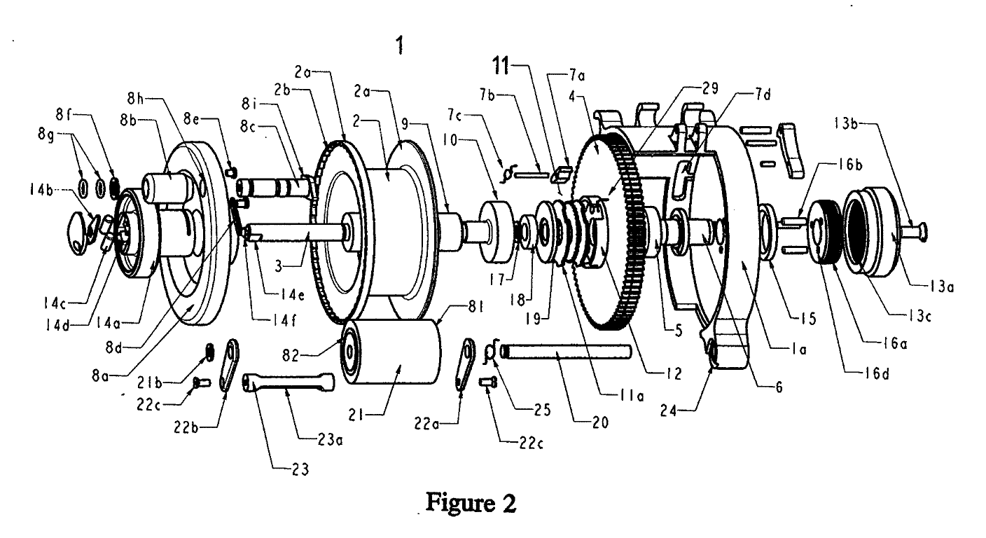

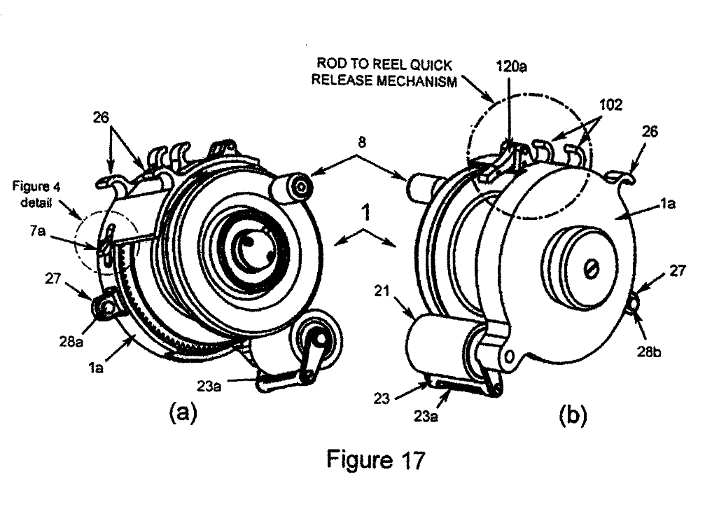

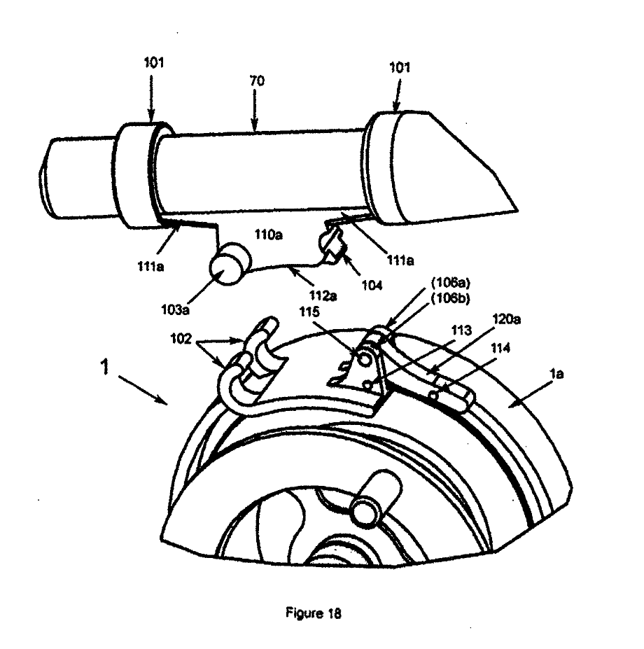

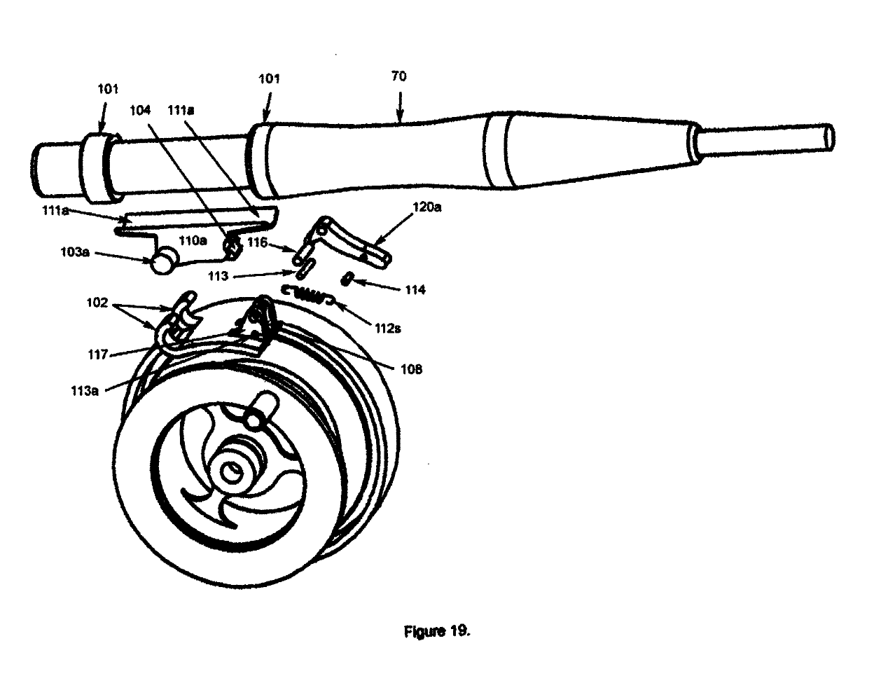

Two line guide supports 22a, 22b FIG. 2 positioned on the roller axle are secured to a line guide 23 FIG. 2 by screws 22c FIG. 2 and said line guide controlling the position of the line in relation to the line roller. The line guide supports 22a 22b and the line guide 23 are free to rotate about the axis of the roller through a limited angle determined by a cut out 24 FIG. 2 in the reel body 1 controlling the rotation of line guide support 22a. The line guide support 22a is spring loaded in one direction by a torsion spring 25 FIG. 2 acting between the said line guide and reel body. When line is pulled from the reel this spring loaded mechanism under force from the line rotates to a position, which allows the line to rotate the roller. The line guide 23 controls the position of the line emanating from the spool 2 for the dispensing and retrieval of the line. The line guide 23 is associated with the line roller 21. The line guide 23 is thus moveable and is biased against the dispensing action of the line. In particular (and as best seen from FIG. 17) the line guide 23 is formed by a rotatable bar which has an elongate slot 23a defined therein and through which the line 80 is threaded. The perimeter of the slot 23a forms the boundary for movement of the line 80 relative to the rollers 21, 35. Roller 21 is supported by roller axle 20 been free to rotate and held in place by clip 21b.

In the current illustrated embodiment the roller 21 connected to the reel 1 is a non-driven roller and the roller located on the docking station 33 is a drive roller 35. The roller 21 cooperates with the drive roller 35 for dispensing and retracting a line. In this way powered dispensing and retracting is provided. Roller 21 can freewheel while line is being paid out or wound in.

Attached to the reel is a detachable rod 70. In FIG. 1 the reel body 1 is docked on a docking station body 33 as described below. This means that the rod 70 is supported by the docking station 33 also. This allows for hands-free securing of the rod relative to an angler.

The reel body 1 supports a fishing line spool and in the embodiment a fly line spool 2. The spool 2 can rotate about the reel axle 3 FIG. 2.

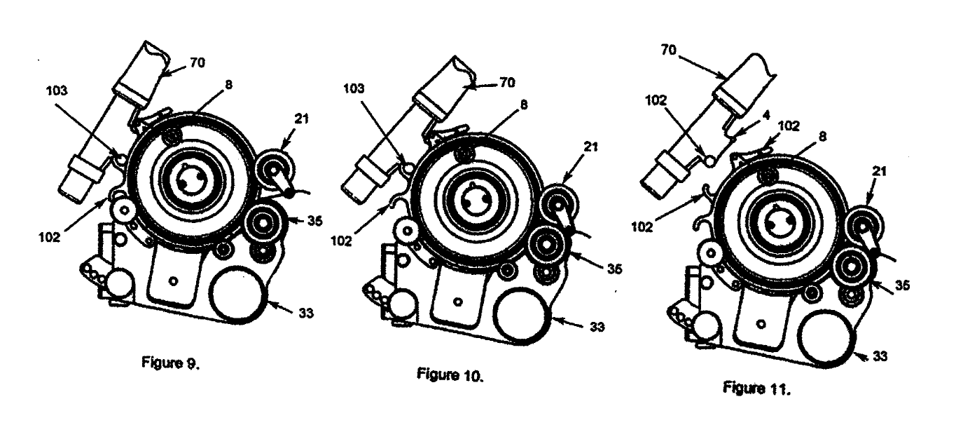

The reel body 1 has two different working positions (best seen in FIGS. 9 and 10) when docked in the docking station 33. The position as illustrated in FIG. 1 and FIG. 10 is one in which the rollers 21,35 are in cooperation with each other by virtue of being sufficiently close proximity to each other to grip a line 80 between them. In this working position powered dispensing and retrieval of the line is allowed while line can be pulled from the reel by hand resulting in the rotation of the rollers but cannot be wound in by hand in this position. The mechanical arrangement which allows this will be described in more detail below. In the non-cooperating position of the rollers (where the reel is docked but the rollers are spaced apart) as shown in FIG. 9 line can be wound in manually or by powered means. In this working position the line cannot be dispensed by powered means but can be pulled from the reel 1 by hand.

FIG. 2 is an exploded view of the reel 1 of the control system illustrated in FIG. 1 for a fishing line of a fishing rod in accordance with the present invention. FIG. 2 illustrates a reel 1 having a reel body 1a and supporting a spool 2 which is rotatably mounted on a reel axle 3. The spool is for holding a wound line. The spool is free to rotate in one direction (a retrieving direction) about the reel axis 3. A separate spool gear 4 is rotatably mounted on a spool gear bearing 5 which is turn is supported by a stationary axle bushing 6 fixed to the reel body 1a. The spool gear 4 is positioned between the spool 2 and reel body 1a and on the same axis as the spool 2. The spool gear 4 is generally free to rotate in opposing directions about the reel axis but its movement can be locked. Movement of the spool gear 4 is lockable by a latch 7a which is rotatably mounted on latch pin 7b which in turn is mounted on the reel body 1a. The latch 7a is biased by a torsion spring 7c acting between the latch and reel body. The latch 7a extends through an aperture 7d in the reel body 1a and is thus operable manually or automatically when connected to the docking station 33 as will be described below. The control system comprises at least two dispensing members 21, 35 but in the embodiment the reel 1 has mounted on its reel body 1a one of the rollers 21. The roller 21 is a free wheeling roller.

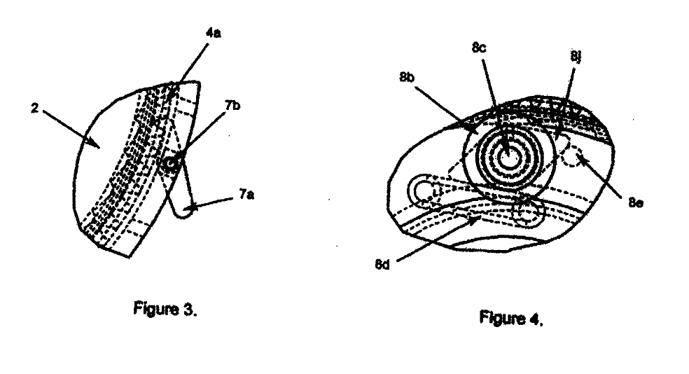

FIG. 3 illustrates the latch 7a as illustrated in FIG. 2 engaging in the teeth 4a of the spool gear 4 to stop rotation. This thus provides a locking mechanism for preventing rotational movement of the spool gear which acts as part of a drive mechanism for the spool. The latch 7a can be disengaged from the said gear 4 at any time when reel 1 is not docked in the docking station thus unlocking it and allowing rotation. When unlocked, by disengaging the latch, all components of the system that turn with the drive gear 4 are free to rotate in both directions.

FIG. 2 also illustrates other components of the system, which in the embodiment are components of the reel, including a spool winding disc 8a also mounted on and free to rotate about the reel axle 3 in both directions. The disc 8a has a manually operated handle 8b which is an eccentric winding handle. There is provided a mechanism (the operation of which is described below with reference to FIG. 4) which allows the handle to rotate the spool when manually gripped and rotated by a user. When powered dispensing or retrieval of the line takes place the handle does not rotate (because the handle is in a deactivated non-gripped state).

If the winding handle had a permanent drive connection to the spool injury may be caused to the angler by the handle when rotating under powered drive. The handle 8b may be manually gripped and then used to wind in line either when the reel is not in the docking station 33 (for example when it is on the rod 70) or when the reel is in at least one working position on the docking station 33. Desirably the working position where the handle 8b is operable is the position shown in FIG. 9 where the reel is engaged in the docking station but the rollers are spaced apart. This allows the reel/rod to be operated as a conventional manually wound (non-powered) reel/rod. When the handle is gripped and rotated rotation of the spool is activated.

The handle mechanism 8 is externally located on the disc 8a. The handle contains a pawl shaft 8c with a pawl 8i fixedly mounted thereon, handle 8b, return spring 8d, pawl stop 8e, shaft circlip 8f and friction rubber o-rings 8g. The handle mechanism has two axes of rotation—the first coincident with the axis of rotation of the winding disc 8a and the second being coincident with a longitudinal axis of the handle itself. The second axis of rotation is offset from but parallel to the axis of the winding disc. This means that the disc 8a is rotated by the handle 8b moving eccentrically.

The pawl shaft 8c is located through an aperture 8h in the winding disc with the pawl on one side of the winding disc 8a. The pawl shaft 8c and the pawl 8i are rotatable relative to the winding disc 8a in both directions about the axis of the pawl shaft 8. The pawl shaft 8c is held longitudinally in position by its profile on the inner side of the winding disc 8a and a shaft circlip (which locates in a groove in the shaft) on the outer side of the disc 8a. The pawl 8i is adapted to engage with teeth 2b on a sidewall 2a of the spool 2. However the default (rest position) of the pawl 8i is a position where it is in a disengaged position. The pawl 8i is held in the disengaged position abutting the pawl stop 8c by bias imparted by the spring 8d.

The pawl shaft 8c forms a mounting axle for the handle 8b and the handle 8b supported on the rubber o-rings is free to rotate (in opposing directions) about the longitudinal axis of the pawl shaft 8c but is this instance has to overcome the resistance of the rubber o-rings to achieve this rotation. When the pawl 8i is not engaged with the spool 2 the spool can rotate without imparting any rotational movement to the handle 8b or the winding disc 8a. Furthermore the handle 8b and winding disc 8a can be rotated relative to the spool without imparting any relative movement to the spool.

However when sufficient gripping and rotational force is imparted to the handle to overcome the biasing force of the spring 8d rotational movement of the handle causes the winding disc 8a to turn and also causes the pawl 8i to rotate so that it catches one or more of the teeth 2b on the spool. This causes the spool 2 to move with the pawl/handle and winding disc. When sufficient force is not present the biasing action of the spring returns the pawl to the disengaged state.

In the embodiment movement of the handle relative to the pawl shaft 8c is achieved by overcoming the friction produced between the o-rings located in grooves on the pawl shaft acting between the handle and the shaft. Drive to the spool is achieved when the handle 8b is manually gripped by the fingers with sufficient force and rotated, overcoming the bias of spring 8d force and engages the pawl on the spool 2. Continued rotation of the handle can occur even after the pawl 8i is engaged with the spool because the friction system employed allows the handle to frictionally slip relative to the shaft but still maintaining sufficient relative rotational force to over come the spring bias from the spring 8d.

FIG. 4 illustrates the operation of the above handle mechanism just described. During rotational movement the handle and pawl shaft rotate in the opposite turning direction than the spool. The pawl then engages with the spool and under further rotation of the winding disc and spool the handle rotates on the pawl shaft under resistance from the rubber o-rings. This rotation of the handle relative to the pawl shaft means that the handle is not rotating relative to the fingers of the angler (thus eliminating friction between the handle and the angler fingers.)

As further illustrated by FIG. 2, a drag mechanism 11 of the invention is operational between the spool 2 and the drive mechanism (spool gear 4) for the spool 2. The drag mechanism 11 of the invention may provide resistance to dispensing rotation of the spool 1, may provide resistance to winding in rotation of the spool 2 or as is desirable and as illustrated in the embodiment provides resistance to both dispensing and winding in rotation of the spool 2. The drag mechanism of the invention is provided by (frictional) discs 11a. A one way clutch bearing 9 is fixedly mounted within the spool body 2 and rotates on a clutch drive bushing 10. The spool 2 is mounted on the reel axle 3 by the clutch bearing 9 and spool body 2. The clutch discs 11a are provided between the clutch pressure plate 19 (which is fixedly attached to the clutch drive bushing 10) and a clutch drum 12. The drum 12 is attached to the spool gear 4.

The drag mechanism 11 is adjustable (for the amount of drag applied) by an adjuster accessible on opposing sides of the spool 2. In the arrangement in FIG. 2, the drag mechanism 11 is adjustable by drag knobs 13a, 14a. The knobs 13a, 14a can be used to set the amount of drag applied. Setting the amount of drag is achieved by rotating one or both of the adjustable drag knobs 13a, 14a which rotate the reel axle 3. The knobs 13a, 14a are located on either side of the reel body 1a and can vary the force applied to the drag mechanism of the invention. This is achieved as follows. The drag knob 13a has an internal threaded feature 13c acting on an external but matching threaded feature on compression disc 16a and said compression disc been able to move longitudinally along the axis of the reel but not having rotational movement due to being held against rotation by three disc pins 16b. The pins 16b are circumferentially arranged about the reel axis and are attached to the reel body 1a and locate in matching holes 16d on the compression disc 16a. The compression disc 16a acts against a spring loaded wave washer 15 providing force when compressed against the reel body 1a.

The reel axle 3 is fixed to the drag knob 13a by a threaded screw 13b in turn acting on a circlip 17 located in a groove on the reel axle 3. The reel axle 3 acts on a clutch bearing 18 which in turn acts on the clutch pressure plate 19 which acts on the drag mechanism discs plates 11a which acts on the clutch drum 12 which acts on the spool gear 4 which acts on the spool gear bearing 5 which acts on the reel axle bushing 6 and which acts on the reel body 1a. In this way drag on the clutch plates can be applied and adjusted by rotating the adjustable drag knobs 13a or 14a acting on the wave washer 15.

On the opposite side of the reel body 1a, drag adjuster knob 14a has two slots 14d that pins 14c fit into. When in the slots 14d in the knob 14a the pins 14 c engage with corresponding cut-out profiles 14e on the axle 3. This allows for adjustment of the drag mechanism and also removal of drag adjuster 14a. Adjusting the amount of drag with this system affects the tension on the line 80. For example when the rollers 21, 35 are in a co-operating position shown in FIG. 1 and FIG. 10 the amount of drag resistance applied to dispensing of the line can be adjusted to a desired tension for example to keep the line sufficiently taut between the rollers 21,35 and spool 2. When a line 80 is pulled from the spool for example by hand or by motorised action or for example by a hooked fish, rotational drive is produced which may turn the spool 2 which will then experience the amount of drag that has been applied by the drag adjustment mechanism.

In such an arrangement drag is used to control overrun on the spool, which can cause line tangles, and also to apply drag to a running fish. When line is manually wound onto the spool in the opposite direction by manual operation of the spool winding disc 8a (as described above) the spool 2 is free to rotate on the reel axle 3 and no drive is produced to the clutch drive bushing due to the action of the one way clutch bearing within the spool. This means that there is no reverse drive transmitted to a motor for driving the roller 35.

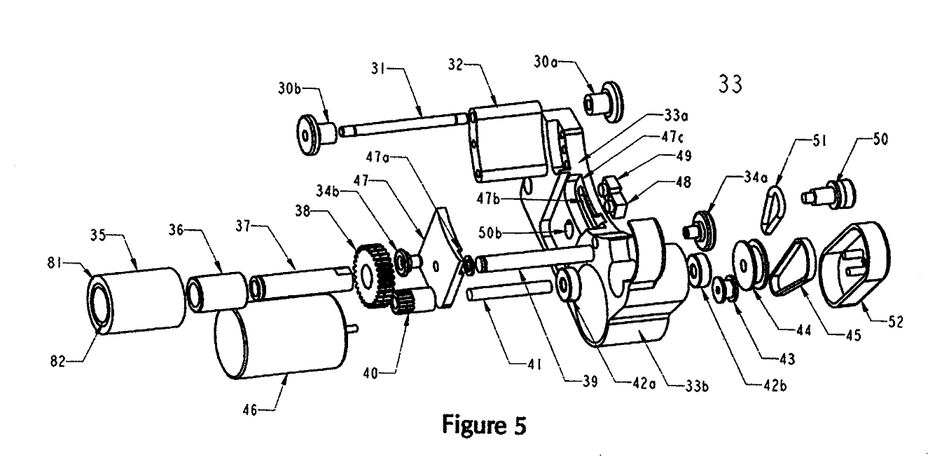

In this instance when the rollers 21, 35 are together in a co-operating position, the line 80 can be pulled from the spool 2 by hand. This action causes the rotation of the rollers and the spool 2. While the rollers are in a co-operating position a line cannot be wound in by hand as the dispensing roller 35 (FIG. 5) rotationally locks due to the action of the one way drive system (one way bearing) 36 FIG. 5 (which is fixed to the roller hub 82) acting against the drive sleeve 37 and drive system. However the line can by powered means (as will be described below) be wound in and dispensed in this position. The roller 35 and spool 2 are driven by one-way drive mechanisms (36 FIG. 5, 9 FIG. 2). This allows the system to be powered for dispensing and retracting the line from and onto the spool 2. Line tension is produced when dispensing line between the rollers 21, 35 and the spool 2, resulting from the rollers pulling on the line and rotating the spool 2 at a slightly faster rotational speed than the rotational speed of the driven clutch drive bushing 10 (which is been driven in the same rotational direction as the spool is travelling) and thus causing the one-way drive mechanism 9 to engage and rotate the clutch drive bushing 10 producing drag between the clutch drive bushing 10 and the clutch drum 12 while rotation is taking place. In this instance the spool is rotationally travelling slowly relative to the spool gear 4 which is also rotating but is travelling fast relative to the reel body 1a. If the line 80 was dispensed by powered rollers pulling line from the spool 2 against a stationary spool gear 4 the result would not be as advantageous as the above described, and would cause more friction and wear on the drag mechanism discs 11a and also take more power to operate. In this position line is wound in by powered rotational movement of the gear wheel 4, clutch drum 12, clutch plates 11a, clutch pressure plate 19 (which is fixed to the clutch drive bushing 10) and clutch drive bushing 10 (rotating in the opposite rotational direction from the above described movement) and rotating the spool 2 which pulls on the line 80 rotating the rollers 21, 35 FIG. 5 (which are turning in the same rotational directional as the drive sleeve 37). In this instance the rollers are travelling at a slower rotational speed than the drive sleeve 37 rotating within, resulting in no drive to the one-way drive mechanism 36 FIG. 5 and leaves the rollers free to rotate. In this instance if there is sufficient resistance to the powered winding in of the line, from example the pull of a fish the clutch plates can slip producing drag on the line.

The second working position as shown in FIG. 8 is one in which the rollers 21,35 are apart (in a non-cooperating position). When the rollers 21, 35 are apart the line 80 can be wound in manually or by powered means (because the spool 2 is driven by a motor). The line 80 cannot be dispensed by powered means in this position (because the rollers 21,35 will not grip a line between them to co-operate to pull line from the spool 2 and also because of the action of the one way mechanism driving the spool). However in the non-co-operating position line 80 can be pulled from the reel 1 by hand resulting in the rotation of the dispensing member or roller 21.

FIG. 5 is an exploded view of the docking station 33 of the control system of the invention that can form part of a control system according to the present invention for example as shown in FIG. 1. The reel body 1a can be docked in the docking station. The docking station 33 comprises a support 33b and a docking receiver profile 33a on the support into which the reel 1 docks. The reel 1 is removably attachable to the docking station 33.

The drive roller 35 (which, as described above and like roller 21 has a pliable outer surface 81) is located on the docking station 33. It is rotatably fixed to the docking station body 33b. A one-way roller bearing 36 which is free to rotate in one direction is mounted on a drive sleeve 37. The drive sleeve 37 is permanently fixed to the roller gear 38. The drive sleeve 37 is rotatably mounted on a roller gear axle 39. The roller gear axle 39 is supported by and fixed to the docking station 33 and in particular the docking station body 33b.

The drive sleeve 37 is free to rotate in both directions on the roller gear axle 39. The drive sleeve 37 is connected through the roller gear 38 to a drive gear 40. The drive gear 40 is permanently fixed to a drive gear shaft 41 and said shaft rotatably supported by a pair of bearings, bearing 42a and a bearing 42b. The bearings 42a, 42b are supported by the docking station body 33b.

The drive gear shaft 41 is connected to a drive shaft pulley 44 which in turn is connected to a motor pulley 43 by means of a drive belt 45. An electrically (for example from one or more batteries or external power supply) powered motor 46 is supported and fixed to the docking station body 33b. The motor 46 is used to drive the roller 35. The motor pulley 43 drives the drive shaft pulley 44, which transmits the rotational motion from the motor to the roller 35. The rotational axis of the drive roller is parallel to the rotational axis of the reel axle 3 and has a similar radial distance from the reel axle as the roller 21. In this way the roller 35 can be driven so that when the reel is docked in the docking station 33 and rollers 21,35 are in working co-operation with each other dispensing of the line is possible. The motor drives roller 35 in a dispensing direction and it cooperates with roller 21 to grip the line 80 there between so that the dispensing rotation of the roller 35 in cooperation with the driven spool dispenses the line. When the reel is docked in the docking station the driving mechanism 38 (FIG. 5) in this instance a gear engages with the driven mechanism 4 (FIG. 2) in this instance a gear and provides drive to the spool through the clutch drum 12, friction plates 11a, clutch drive bushing 10 and one way bearing 9. A drive belt cover 52 is provided to protect the pulleys and the belt from damage.

A state of art release mechanism is provided with release arm 14b FIG. 2 engaged in external groove 14f at the end of the reel axle 3. When the release arm is manually activated the drag adjusting knob 14a and components, winding disc 8a with handle assembly and spool can be removed from the reel axle 3. This is to accommodate exchanging the spool with another spool that would have a different line attached or for cleaning or maintenance purposes and this mechanism is commonly used on nearly all of today's fly reels. Also a state of art click mechanism spring 29 located between the spool gear and drag mechanism and engaging in serrations on one of the drag discs audibly monitors the speed of the spool relative to the spool gear. Again this type of mechanism is in use on most of today fly reels and provides the angler with a sense of how fast line is been dispensed from the reel.

The docking station 33 is further adapted for receiving and docking the reel 1. In particular the docking receiver 33a is part-circular in shape and also provided on the docking station 33 are rollers 30a, 30b located on a roller shaft 31 each on opposing sides of the docking station. A further curved support plate 32 is connected to the docking station body 33. The rollers 30a, 30b are free to rotate in both directions on the roller shaft. Two further rollers 34a, 34b (each also on an opposing side of the docking station) are provided on the opposing side of the receiver 33a. Together the rollers, 30a, 30b; 34a,34b, and the receiver 33a and the curved plate 32 form a part-circular receptacle or mating cradle for the reel 1. The reel 1 can be twist-locked into the docking station 33 by engaging with one or more or all of, the rollers, 30a,30b;34a,34b. These components interact with the reel 1 as will be described in more detail below after the reel is explained in more detail.

The reel 1 is independent and fishable in its own right having a configuration where it can be fished as a manually powered reel. However in accordance with the invention the reel 1 can be docked, by itself (with no rod) or optionally together with the rod in the docking station 33. A reversible sequence for attaching a reel optionally together with a rod to a docking station 33 of the invention is shown in FIGS. 15(a) to 15(c). In FIG. 15(a) the docking station 33 is provided on a belt 61 (a flexible body belt) about the waist of an angler 62. In FIG. 15(a) the reel 1 is on the rod 70 and the rod/reel assembly can be fished as normal. In FIG. 15(b) the reel 1 has been docked in the docking station 33 and the rod being attached to the reel is also held by the docking station. In FIG. 15(b) the rollers are in the cooperating configuration and the roller 35 is powered by the motor 46 of the docking station. The spool 2 is also driven by the motor 46 and power to roller 35 can be used to dispense line in co-operation with spool 2 while power to the spool 2 allows for winding in of line. The rod 70 can be removed leaving the reel 1 attached to the docking station as shown in FIG. 15(c). The rod can be utilised as normal, to cast etc. It is lighter and easier to use because it does not have the reel attached. The sequence can be reversed by re-attaching the rod 70 to the reel 1 and then removing the reel 1 from the docking station 33.

FIGS. 17(a) and (b) and FIG. 18 show the reel body 1a the surface of which has hinge elements thereon. In particular semi-circular hinge elements 26 are provided for quickly attaching or detaching the reel to a docking station 33. A cam lug 27 and cam followers 28a,28b (on opposing sides of lug 27) are also provided on the reel body 1a for retaining and positioning the reel 1 in the docking station.

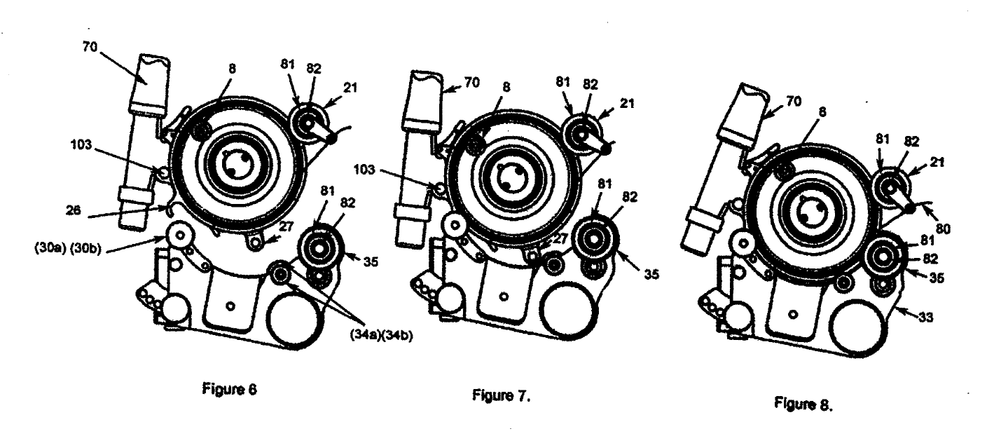

FIGS. 6 to 11 illustrate the mechanism by which the reel 1 is engaged with the corresponding docking station 33. The sequence from FIG. 6 to FIG. 11 is reversible. As shown in FIG. 6, the reel 1 is initially disengaged from the docking station 33. It is presented thereto in a mating orientation as shown in FIG. 6,

As shown in FIG. 7 the reel 1 is initially located (in this instance is done using rod 70 which is attached to reel 1 in this sequence) and partially constrained by means of semicircular engagable hinge mechanism members 26 on the reel body 1a engaging with the docking station 33. In particular the semicircular hinges or hooks 26 locate on rollers 30b, 30a. The reel body 1a is at least part-circular in shape with the central axis of that part-circular shape being coincident with the reel axle 3. This means that after the initial engagement of FIG. 7 the reel may be rotated about its own central axis (the reel axle) to engage the reel 1 in the docking station 33 (as shown in FIG. 8). It will be appreciated that the reel 1 may be engaged with the docking station without relying on firstly engaging the hinge members 26 with grip rollers 30b, 30a. A degree of rotation may be required before that position is reached. In any event the reel 1 is rotated with the hinge members 26 engaged until such a position is reached that the body 1a of the reel 1 comes into contact with the two rollers 34a,34b. In this position the spring loaded latch 7a FIG. 3 (which in a default biased position locked the spool gear 4 to the reel body 1a) now is unlocked by contact with the docking station body 33a (which overcomes the biasing force). Simultaneously the spool gear 4 meshes with a roller gear 38 on the docking station so that the roller 35 and the spool 2 are now engaged with the motor 46. This is a first docked configuration where the roller 21 and the roller 35 are spaced apart (as shown in FIG. 8). In this position the reel body 1a is now also in contact with and supported by rollers 34a,34b,30ba and 30b.

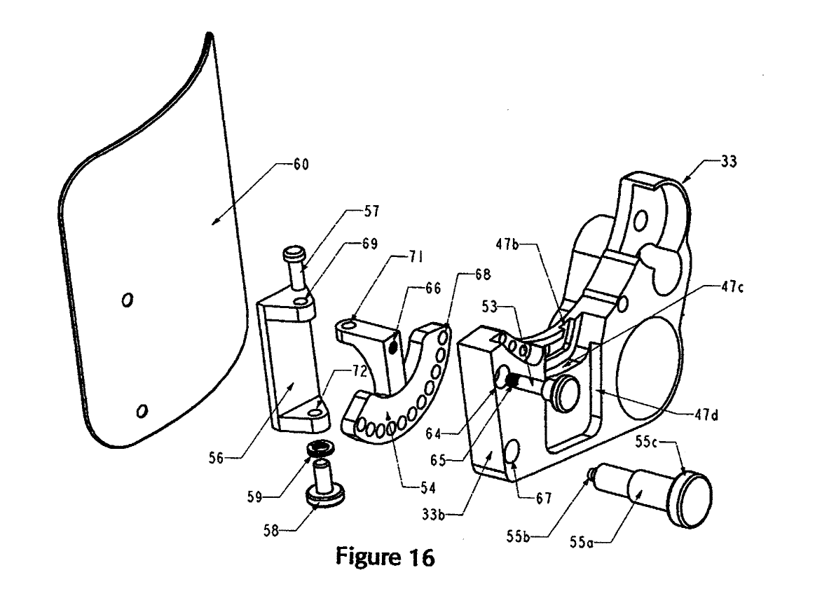

On further rotation of the reel body 1a on each of the rollers 30a,30b;34a34b, the pivot point for rotation changes from the hinge portions 26 to the central axis of the reel 1 and the hinge mechanism becomes progressively disengaged as shown in FIG. 9. The reel 1 is now effectively turning on its own central axis by virtue of being cradled by the rollers. This results from the reel body 1a in contact with the said rollers having a circular shape where the centre of this said shape corresponds with the centre of the reel axis. In the position of FIGS. 9/10 the reel 1 is now partially constrained on the rollers 30a,30b;34a 34b by a cam lug 27 and an inner cam 28a positioned on the cam lug 27. The cam lug 27 travels in a semicircular open sided arc profile 47c FIG. 16 between the docking station body and the cam slider plate 47 FIG. 5 constraining the reel body movement in the same plane as the reel axis and cam 28a also travelling with the cam lug in a uniform defined arc 47b FIG. 16 in the docking station body 33b and said cam 28a constraining the reel body in a plane perpendicular to the reel axis and anchored to the rollers 30a,30b;34a 34b but allowing circular movement of the reel body about the reel axis. A cam slider plate 47 FIG. 5 has a matching and mirror imaged semi circular profiled cam path 47a which together with the cam path 47b on the docking station provides a pre-defined pathway for the cams to travel. Furthermore the cam slider plate 47 is spring loaded to allow for controlled rotational movement in profiled path 47d (located within the plate 47) and 47b (located within the docking station body 33) FIG. 16 and holding the reel body against rollers 30a,30b;34a and 34b. The slider plate 47 is held in place within the profiled path 47d FIG. 16 by the slider plate shoulder bolt 50 allowing movement only in a plane perpendicular to the reel axis.

There are provided two separate and spaced profiled depressions along the cam path 47a on the slider plate 47 to position and hold the reel in the first of two working positions of the system (FIG. 13). The reel body 1 has two different working positions when docked. The first working position (position 1 FIG. 9 and FIG. 13) reached by the cam lug and cams along the profiled paths is where the cam 28a engages in the first depression and holds the reel in a biased position where the rollers 21,35 are spaced apart as illustrated in FIG. 9. In this position the inner cam follower 28a activates a proximity switch 48 located on the docking station to allow electrical power to the motor 46. This is the first control switch for the motor 46. Power for winding in is not then available until the reel is properly docked and rotated to this position. When the rollers 21,35 are in a non-cooperating position dispensing of the line 80 under electrical power is not allowed but line can be wound in under electrical powered in this position. Line can be manually wound onto or pulled off the spool in this position. Good line tension on the spool when retrieving line in the non-cooperating position is achieved by clinching the line between the fingers as is presently practiced.

Further rotation of the reel 1 about its centre brings the cam lug 27 and cams 28a,28b to the second working position where the cam lug 28a engages in a second depression on the cam path 47a located on the slider plate 47. In this position the roller 21 on the reel and the roller 35 on the docking station are in close proximity and so can cooperate to dispense line (see FIG. 10). The line roller 21 with associated line 80 comes into contact with the drive roller 35 and clinches the line between the said rollers 21, 35. In this arrangement the rollers 21,35 are biased toward each other by the action of the second depression of the cam path acting on cam 28a. This means the rollers can continue to cooperate even if there are variations in the distance between them, for example different thickness of line without losing drive. Sufficient force is imparted from the spring loaded cam slider plate 47 with profiled path 47a acting on the cam 28a to allow the line to be dispensed when the system is in motion and the said rollers been spring loaded and rotating about the centre of the reel. In this position a second proximity switch 49 (as shown in FIG. 5) is activated by the outer cam 48b allowing both dispensing and retrieval of line in this position by power from the motor 46. The rollers 21, 35 are in a cooperating position in the second working position.

FIG. 11 shows the second working position with the rod 70 now released from the reel 1.

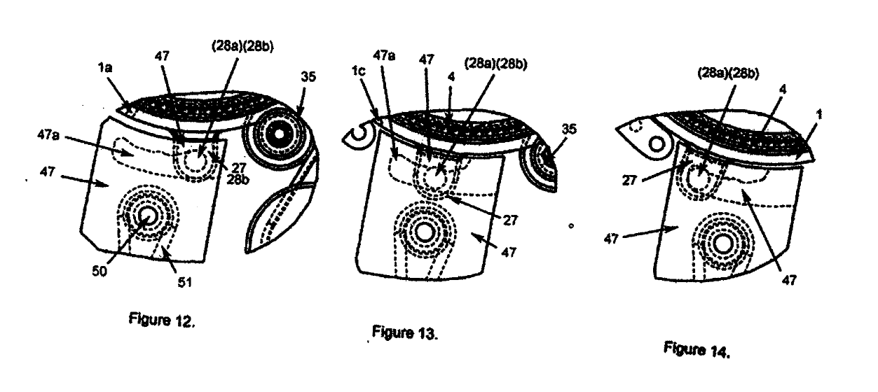

FIGS. 12-14 show enlarged views of the different positions of the reel 1 and cam lug 27 and cam followers 28a, 28b when docked. As illustrated in FIGS. 12-14, the cam slider plate 47 travels in a matching slot 47a defined in the docking station body 33b. The movement of the plate 47 is partially constrained by a biasing force exerted by a slider plate shoulder bolt 50 FIG. 5, been attached to the cam slider plate 47 and a spring 51, being anchored to the docking station exerting a pulling force between the docking station 33 and the slider plate shoulder bolt 50. The slider plate shoulder bolt 50 travels in an elongated slot 50b in the docking station having clearance and its movement constrained by the slot length.

When dispensing line 80 off the spool 2 the rollers 21,35 act as the dispensing members. Drive to the rollers 21,35 is achieved by rotation of the motor 46 turning the motor pulley 43 which turns the drive belt 45 which transmits the rotation to the drive pulley 44 which in turn transmits the rotational motion to the drive gear 40 been connected to the drive gear shaft 41 acting on drive gear 38 acting on drive sleeve 37 acting on the one way clutch bearing 36 which is drives roller 35. The roller 21 is driven by the motion of roller 35. Also rotational drive is transmitted to the spool 2 by the interaction of drive gears 38 and 4.

The gearing of the drive mechanism is arranged so that for every single revolution of the pitch circle diameter (PCD) of the spool gear 4 the circumferential distance travelled is equal to the circumferential distance travelled by the drive roller surface 35. This results from the PCD of the roller gear 38 being equal to the diameter of the drive roller surface 35. As the PCD of the spool gear 4 is selected so as to be always greater than the diameter of any line 80 on the spool this means that the rotational speed of the drive roller 4 is always greater than the speed of the line 80 coming off the reel 1. This difference in rotational speed creates line tension between the rollers 21,35 and the spool 2 and is of great benefit in keeping the line 80 under control while being dispensed.

If the drag mechanism 11 is adjusted by the drag adjusting knobs 13a,14a to a fully adjusted (for example locked) position the line tension would be greatest between the dispensing rollers 21,35 and the spool 2. This line tension can be adjusted to achieve a moderate tension on the line 80 between rollers 21,35 and spool 2 and results in a controlled dispensing of line without any slack line problems or overstraining the system. Less power is needed to rotate the system when a moderate tension is set. Under moderate tension rotational speed of the spool 2 is slightly faster than the rotational speed of the spool gear 4 resulting in a slow rotational speed of the spool 2 relative to the spool gear 4 in a direction, which causes drive through the one-way clutch bearing 9 to the drag mechanism 13. This relative rotation can be heard when dispensing line by a relatively slow click coming from the clicking mechanism spring 29 even when the reel 2 is dispensing line at a fast rate through the rollers 21,35.

When the reel 2 is disengaged from the docking station 33 the click monitors the speed of the rotating spool 2 relative to the non-rotating spool gear 4 but in this instance the click is monitoring the relative slow speed of rotation between the rotating spool 2 and rotating spool gear 4. The drag mechanism 11 on this system has a dual function, to act as a state of art drag mechanism and also for adjustments to the line tension between the rollers 21,35 and spool 2.

Line retrieval is possible in the second configuration or working position of the reel in the spool. It is achieved by rotation of the spool 2 under power from the motor 46 through the one way clutch bearing 9, drag mechanism 11, spool gear 4, roller gear 38, drive shaft 41, drive shaft pulley 44, drive belt 35, and motor pulley 43 and said spool 2 pulling on the clinched line and pulling it through and rotating the rollers 21,35 (both of which free-wheel in the winding in direction). Rotation of the rollers 21,35 results from their close co-operation gripping the line 80. The gripping of the rollers is provided by the gripping surface formed by the pliable nature of a cover 81 on the roller thus causing sufficient gripping of the line 80 to cause both rollers 80 to rotate as the line is drawn through the rollers 21,35 as it is drawn in. This resistance produces line tension between the spool 2 and rollers 21,35 resulting in a properly wound spool of line. In this instance drive is not transferred to the drive roller due to the drive sleeve rotating at a faster speed than the roller and allows the one-way clutch bearing 9 to act in a freewheeling state relative to the drive sleeve 37. In this position line 80 can be manually pulled off the spool 2 with both rollers 21,35 rotating but cannot be manually wound onto the spool 2, due to the locking action of the one-way clutch bearing 9 on the drive sleeve 37.

Unlike other systems pulling line off the reel when docked in the docking station does not affect the casting hand during the casting stroke. In other systems because the reel is on the rod and the rod is held by the casting hand some coordination between both hands is necessary to allow the free hand to pull line off the reel on the rod held during the casting stroke.

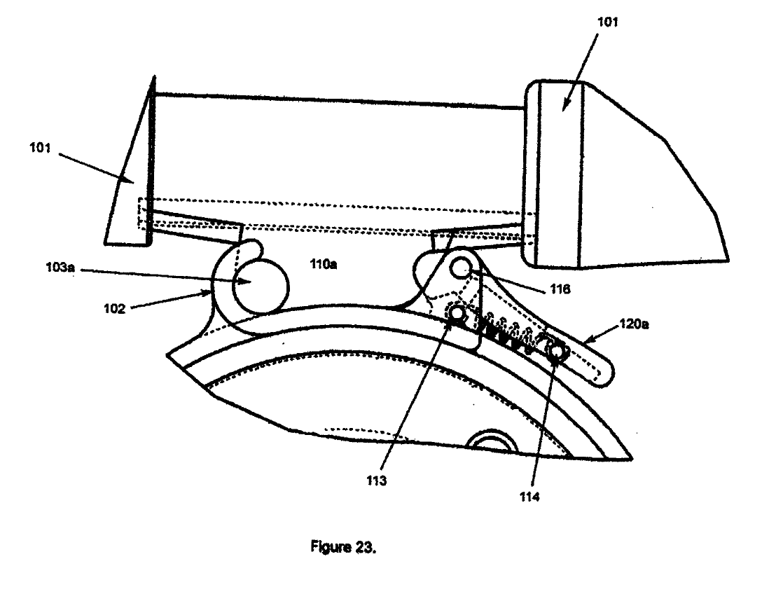

In one embodiment, the docking station 33 and desirably the entire control system and suitably including the rod 70 may be attached to the angler 62 by a flexible body belt 61 and said belt is secured around the waist of the angler. This is illustrated in FIG. 15. In particular FIG. 15(a) shows a docking station of the invention. The reel 1 together with the rod 70 can be separated from docking station and manually operated, as illustrated in FIG. 15 (a). In addition, the rod 70 can be detached from the reel 2, the reel 2 remaining attached to the docking station 33 on the flexible belt 61 around the angler 62, as illustrated by FIG. 15 (c). The angler 62 can fish without the reel 1 attached to the rod 70 so there is less weight on the casting hand 63. All the weight of the control system is now carried around the angler's waist and is barely noticeable. At any time, while fishing the angler 62 can attach the rod 70 to the docked reel 1 using a quick release mechanism (as illustrated and discussed below in relation to FIGS. 19-24), thus leaving the angler 62 the use of both hands to do any task required for example changing casts or lines, releasing a fish from the landing net etc.

With the rod 70 in this position the docking station 33 and rod 70 can be rotated to any position, for example rotating the rod behind the angler's shoulder when moving to a different fishing location. This movement is because of pivotal attachment of the docking station 33 to the belt 61 as described below. This leaves the angler with the use of both hands to negotiate obstacles and less chance of damage to the angler or the rod. If the angler wants to keep the reel 1 with the rod 70 simple rotation of the reel 1 in the docking station 33 while holding the rod handle releases the reel 1 from the docking station 33. This can be done using one hand. The angler can fish as the norm with the (fly) reel attached to the (fly) rod as illustrated in FIG. 15 (a). With the reel 1 in this position the drive mechanism is locked. The drag mechanism 11 is operational by applying drag between the locked drive mechanism and the spool and acts the same as conventional drag mechanisms (where drag is operational between the body of the reel and the spool). When the angler is finished fishing the fly can be removed from the cast, the line can be wound in by hand or powered means and the reel can be released from the rod or the reel from the docking station. The docking station can also be removed from the body belt for storage if required.

The system can be manufactured in a right or a left hand version depending on whether the angler is right or left handed. The belt can be rotated circumferentially about the angler waist to position the system at the appropriate location for whatever situation arises.

The rod and docking station can be positioned in an infinite number of compound angles relative to the angler, and in particular can be adjusted both left or right and up or down. This angular positioning can be used to position the rod for any of several different reasons, for example to move the rod out of the way and leave room for tying on flies, to point the rollers so that the line can be dispensed at different angles, to position the docking station with reel in a position where the line can be pulled directly off the reel at right angles to the reel axis, (unlike conventional systems where the line is pulled from the reel at an angle to the reel axis and causes wear on the reel body, line guides and damage to the fly line), to position the rod behind the angler for example vertically behind an angler's shoulder for walking or moving to a different location leaving the angler's hands free, or to fold away for storage etc.

FIG. 16 is an exploded perspective view of the docking station 33 and a means for attaching the docking station in this instance to a body belt. In particular the docking station 33 of the invention is pivotally attached to the body belt 61 (see above) by being pivotally attached to a body plate. In particular the body plate 60 is a plate having a curved profile to approximately match the body shape of (the waist of) an angler for example about his waist level. The plate 60 is in turn fixed or detachably attached to the flexible body belt 61. For example in FIGS. 15(a) to 15(c) it is sewn into the belt 61.

The docking station 33 is attached to the body belt by means of an pivot pin 53 fixed to an index hinge plate 54 by threaded means, inserting the pin 53 through an aperture 64 in the docking station support 33b. The pin 53 has clearance in aperture 64 and the docking support 33b is thus pivotable about the pin 53. Threads 65 on pin 53 engage in a threaded bore 66 on the hinge plate 54. This constrains the said docking station to pivot circumferentially relative to the hinge plate 54 about the axis of the pivot pin 53. A spring loaded index pin 55a is mounted and fixed through an aperture 67 in the docking support 33b. An array of adjustment apertures 68 are located on the index hinge plate 54 and are arranged in a part-circular fashion about the axis of the pivot pin 53 allowing different angular positions of the docking station/rod to be chosen by inserting the spring loaded index end 55b of the index plunger 55a into the desired aperture 68. This sets the angle of the docking station 33 relative to the support plate 60 and thus ultimately sets the angle of the reel (and also optionally the rod) to the angler 62. The index pin 55a is biased toward engaging within one of the apertures 68. Manually pulling a knob end 55c of the index pin 55a retracts the index end 55b internally into the index pin 55a sufficiently to allow relative movement of the docking station 33 to the hinge plate.

The index hinge plate 54 is connected to a hinge support 56 by a pivot point whose axis is vertically aligned relative to the body belt 61. The hinge support 56 is fixed to the body plate 60 by any suitable means. The pivot point is provided by a hinge pin 57 which fits through an aperture 69 on the support 56 and through an aperture 71 on the hinge plate 54 thus pivotally connecting the docking station 33 (through hinge plate 54) to the hinge support 56. The docking station can be moved left and right relative to the support plate 60 and thus the angler 62 about this pivot. A drag knob pin 58 is also positioned along the pivot axis being connected by thread to the index hinge plate 54 by insertion through an aperture 72 in the hinge support 56. Manual rotation of the drag knob pin 58 adjusts the amount of resistance to pivoting the docking station 33 about the pivot axis relative to the docking support. This is achieved by arranging the drag knob 58 to exert an adjustable amount of compressive pressure on a spring washer 59 positioned between the drag knob and the hinge support 56. If pressure is sufficiently released the docking station 33 is free to pivot under applied pressure. Free pivotal movement of the docking station 33 may be used for example to follow the path of the reel/rod about the angler when playing a fish. When it is desired to do so the knob 58 can be utilised to provide sufficient resistance to effectively lock the position.

The present invention also provides a quick release mechanism for releasably attaching the reel 1 to the docking station 33 or the rod 70 to the reel. FIGS. 17 through 23 illustrate various views of a mechanism according to the invention. The mechanism for attaching the reel 1 to the docking station 33 has been described above. The quick release mechanism for releasably attaching the reel 1 to the rod 70 will now be described.

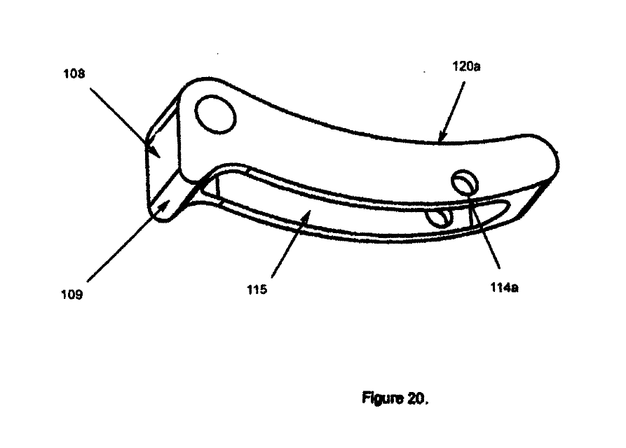

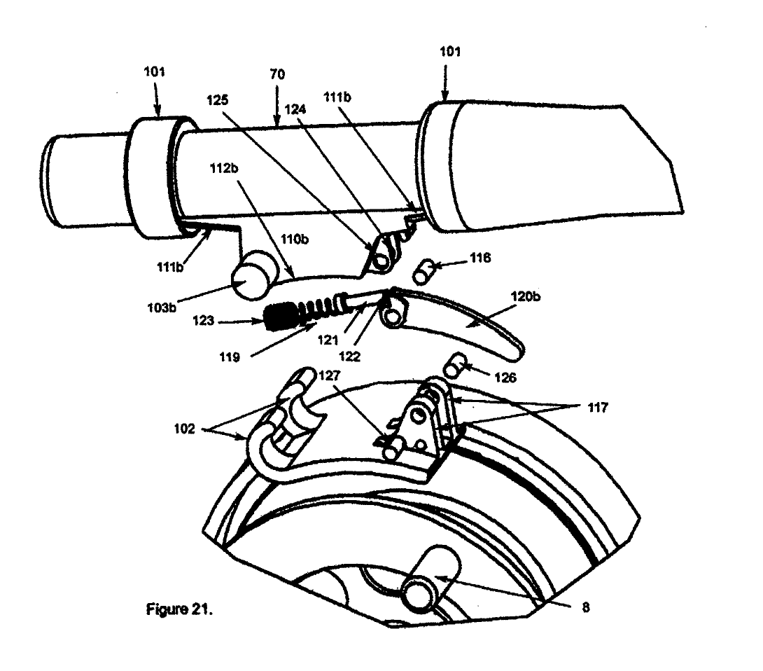

FIGS. 18 through 20 illustrates the rod 70 and the reel body 1 and their interacting elements that comprise the quick release mechanism. The reel bracket 110a has, at a first end thereof an elongate reel foot 111a which is for attachment to (and is engaged on) the rod 70 at opposing ends thereof by rings 101 and said bracket can be permanently left on the rod when the reel is disengaged from the rod. The bracket 110a has a second end 112a which is for attachment to the reel 1. A quick-release mechanism for releasably securing the reel 1 to the bracket is provided to releasably secure the reel 1 to the second end 112a of the bracket 110a. A first co-operating portion in the form of two pivot pins 103a located on either side of bracket 110a and a cambered surface 104 is provided on the bracket 110a. The quick release mechanism further includes a second co-operating portion in the form of curved receivers 102 on the reel and a biased latch 120a which together engage with the first co-operating portion on the bracket to automatically secure the reel 1 to the bracket 110a when the two cooperating portions are mated. In particular the two co-operating portions mate by inserting a first end, and in particular pins 103a into the curved receivers 102 and using rotating action engages the mechanism by pivoting bracket 110a to a position where surface 104 firstly leverages and rotates latch 120a acting against surface 108 (FIG. 20) and the biased action of the latch until such a position is reached where surface 109 (FIG. 20) is reached allowing latch 120a to change direction locking surface 109 against cambered surface 104 by the biasing action of the latch. Locking may thus be achieved by holding the rod handle 70 in one hand and the reel 1 in the other hand or in the docking station, then locating the different elements of the hinge mechanism together and rotating the rod and reel together until the locking mechanism clicks into place. Opening is achieved by rotating the latch 120a which allows the rod and bracket 110a to rotate within the curved receivers 102 to a position where they can detach from the reel. This can allow for fast release of the reel from the rod whether the reel is docked or not. For example this allows for a faster change of reels for example when fishing in competitions. The latch 120a is a biased latch, which automatically secures the reel to the bracket when the two cooperating or interacting elements on the rod and the reel body are mated. FIG. 19 shows an exploded view illustrating that the biasing force is applied by a spring 112s which is tensioned between pins 113,114, where pin 113 is located into aperture 113a on mounting brackets 117 and pin 114 is inserted into aperture 114a in latch 120a. The latch 120a is pivotally mounted by a latch pin 116 on a pair of mounting brackets 117 which have an aperture 108 to receive the pin 116. The latch 120a forms a hollow chamber 115 (see FIG. 20) within which spring 112s is accommodated. The rod or reel when fitted with either corresponding member parts of this mechanism can now be connected to or detached from any object in seconds where that object has the same corresponding hinge mechanism attached, for example to a boat or to the angler or a rod and reel holding stand, or a weight simulating the weight of the reel or indeed any other object.

When the latch is positioned on the reel this leaves the rod free of the latch 120a mechanism which may interfere with the angler's hand grip for example while casting etc. The reel body 1 can be docked in the docking station 33 while still attached to the rod (as illustrated In FIGS. 19 and 20 and then the latch 120a may be used to release the rod from the docked reel.

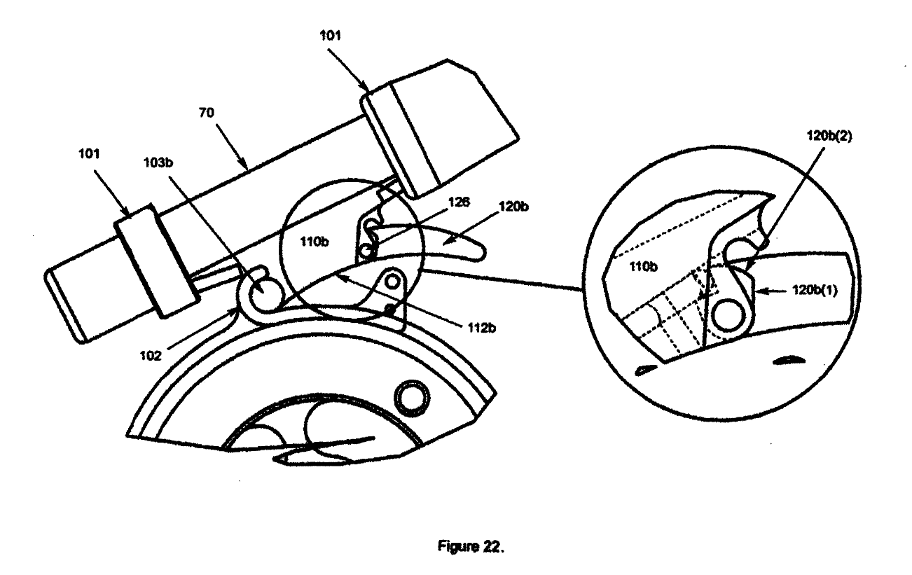

A similar but different interchangeable quick release mechanism is shown in FIGS. 21 through 23. In the embodiment the latch 120b is on the reel bracket 110b (instead of being attached to the reel 1) but the mechanism is similar and the same reference numerals denote use of similar parts. In this embodiment the latch 120b is biased by a compression spring 119 acting against a push rod 121 which in turn acts against a seat 122 on the latch 120b. An adjustment screw 123 can vary the compressive force imparted by the spring 119 to the latch 120b. The adjustment screw 123 and the spring 119 are mounted within the reel bracket 110b. A pivot pin 116 pivotally mounts the latch 120b on mounting brackets 124 by insertion through apertures 125 therein. In the arrangement the latch 120b is biased to lock against two locking pins 126,127 inserted through apertures 108 in mounting brackets 117 on the reel 1. The latch 120b clicks into position when the bracket 120b rotates in the two curved receivers 102 to a point where the surfaces 120b(1) FIG. 22 located on both sides of latch 120b acting against pins 126,127 rotates latch 120b pivoting on pin 116 and acting against the biasing action of spring 119. Latch 120b rotates in between pins 126 and 127. Further rotation allows latch 120b to change direction and lock surfaces 120b(2) FIG. 22 against pins 126,127. The reel can thus be locked to the rod.

Depending on the anglers choice the locking mechanism can be changed from being on the reel 1 (FIG. 18) to being on the reel bracket 110b (FIG. 22). For this change over the following locking mechanism members located on the reel are detached by removing (see FIG. 19) latch pin 116 (from aperture 108) and the extension spring reel pin 113 (from aperture 113a) and replaced by the two short locking pins 126,127 inserted into apertures 108. Bracket 110a located on the rod is then replaced with bracket assembly 110b holding parts 116,119,120b, 121,122 and 123.

When in use the angler takes the reel 1 and pulls the line 80 from the spool 2 against the resistance of a drag mechanism 11 and threads the line through the line guide 23 (in particular through slot 23a thereof) on the reel. The free wheeling roller 21 covered with a pliable coating is in contact with the line 80 and the line guide 23 keeps the line within the limits of the spool walls or rims 2a. When the line is pulled from the spool 2 this causes both rollers 21, 35 to rotate (they are suitably in the working position shown in FIG. 1). The line can be pulled from the reel 1, by powered means (in particular by motor 46), and may also be wound in by powered means (in particular by motor 46) and may thus be easily dispensed in this position. To dispense the line using the powered system the angler 62 switches on power and then selects the manually controllable position on the secondary switch and then by operating a control switch, for example a pressure sensitive rocker switch, which may be located on the belt 62 or on the rod handle 70a and used to control operation of the motor 46 to dispense the line. In a preliminary step enough (fly) line 80 may be dispensed by powered rotational movement of the rollers pulling line off the spool so that the line can be threaded through the rod rings 73 (see FIG. 15(a)-(c)). The handle 8b of the reel 2 does not rotate when under powered means so no accidental damage can be done to the angler by a driven (fast spinning) handle. When the handle 8 is turned manual drive to the spool 2 is activated. Once the line is threaded through the rod rings, the bait (for example the cast and fly) are attached to the end of the line and the angler can fish. The line can be dispensed or retrieved as required. When dispensing the line the rollers 21, 35 can move at a faster surface speed than the line coming off the spool 2 which is also rotating. The rollers pull the line from the spool 2 and act against the drag on the reel provided by drag mechanism 11. This action keeps tension between the rollers 21, 35 and the spool 2 and eliminates the possibilities of the line getting tangled. When retrieving the line the rollers 21, 35 are in a free wheeling state and the spool 2 which is then driven pulls the line 80 through the rollers 21, 35. In this state the line tension is achieved by the resistance of the rollers 21, 35 to rotate due to their pliable surface. The line can be moved back and forth by the line hand thus maintaining a uniformly wound spool of fly line. Any slack line can be wound onto the spool by powered means thus minimising the chances of getting the line tangled and loosing a fish. When playing a fish the reel 1 is generally either on the rod or in a working position in the docking station. The preferred position is when the rollers 21,35 are open i.e. in a non-cooperating position (such as is shown in FIG. 9, which eliminates the extra drag coming from the rotating rollers. The fish can pull on a line from the spool 2 against the drag on the reel. The angler can by powered means rotate the spool 2 acting against the drag on the reel. The angler can be powered means rotate the spool 2 to wind in line even if a fish is pulling the line out. This can also increase the drag on a fish and the moment a fish turns and heads in the direction of the angler even at high speed, the line tension between the reel and the fish is maintained by the ability of the powered mechanism to wind in line at a greater speed than the fish is travelling. This is typically much faster than is achievable using manual winding in of the line. The constant tension leaves less chance of the hook of the line becoming dislodged and loosing a fish. This is of more importance now with the advent of barbless hooks. The system gives the angler the ability to play the fish with constant tension using one hand and leaves the other hand free, giving the angler much more control over the situation. When the reel is docked in the docking station the tension and pull on the line is between the fish and the docking station and the rod is used to lift the line to introduce a spring effect into the tensioned line. This means that the angler now feels less fatigue on the rod arm when playing a fish. The angler also now has the ability to slide the rod along the line without moving the line. In another instance the fish can be played while the rod is attached to the reel and the reel docked in the docking station. This may be of assistance as it gives the angler the use of both hands or to disabled anglers or when the fish is ready for landing. The angler can also adjust the drag on the reel. Setting the amount of drag is achieved by rotating the reel axle 3 which has adjusting knobs 13a and 14a located on either side of the reel. The docking station 33 can rotate (left or right and/or up and down) to keep the line guide 23 and the reel 1 facing in the direction of pull coming from the line and the rod. This pull on the line also causes the line guide 23 which is spring loaded in one direction to rotate about the axis of the roller on the reel 1 keeping the line in contact with the roller 21 and lessening the resistance and wear effect of the line as it travels across the surface of the line guide. Adjusting the amount of drag with this system also affects the tension on the line between the rollers 21, 35 and the spool 2 when the rollers are in close proximity to each other.

Activating a secondary switch on the control system or the body belt can change the system over to automatic control where the line is wound in and dispensed automatically without intervention from the angler. This may be achieved by a sensor device 73 FIG. 15a mounted on the rod 1 which monitors the line speed and direction. As the line is pulled in by the angler or pulled out by the momentum of the cast the sensor monitors the amount and signals the reel by wireless means to wind in or dispense the same amount from the spool 2. Before switching over to automatic the angler could make sure there is a sufficient amount of slack line between the reel and the rod to enable a successful cast. This amount of slack line would always be maintained by the automatic system thus not allowing extra loose line to accumulate on the ground or in the water. If the angler needed more or less slack line activating either rocket switches would temporarily override the automatic system and lengthen or shorten the slack line. If a fish is hooked when in automatic mode the angler activates the switch to wind in the loose line which overrides the automatic system and the angler can now switch off the automatic function. The angler can also fish without the reel attached to the rod as further illustrated in FIG. 15(c).

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

### CROSS REFERENCE TO RELATED APPLICATION

The instant application claims priority under 35 U.S.C. §119(a) of Ireland Patent Application No. S2010/0109 filed Feb. 26, 2010, the disclosure of which is expressly incorporated by reference herein in its entirety.

I claim:

1. A control system for a fishing line of a fishing rod, the control system comprising
a. a reel with a spool having a fishing line,
b. at least two cooperating dispensing members arranged about the reel,
whereby the line emanates from the spool and is disposed between the dispensing members such that a rotational cooperating action between said dispensing members dispenses the line.

2. The control system of claim 1 wherein the dispensing members are rollers between which the line is held and at least one of said dispensing members has a pliable surface for gripping said line when dispensing said line and the pliable surface furthermore providing resistance to rotation of said dispensing members when said line is been wound in by the spool thereby producing tension in the line between said spool and said dispensing members.

3. The control system of claim 1 further including a drive mechanism on the reel, interacting between the dispensing members and the spool and firstly providing means for driving rotational motion of said spool when winding in the line and secondly providing means for rotational motion of at least one of said dispensing members for dispensing said line and furthermore providing means for rotational motion of said spool to aid in the dispensing of said line by said dispensing members.

4. The control system of claim 3 further including a locking mechanism provided on the reel for preventing movement of the drive mechanism when said locking mechanism is activated.

5. The control system of claim 1 comprising a dispensing member which is driven, and a dispensing member which is not driven, and wherein the spool is driven, and further comprising a power unit which can be selectively operated to drive at least said dispensing member which is driven for dispensing the line or to drive rotational motion of said spool to wind in said line.

6. The control system of claim 5 wherein the driven dispensing member is driven by a one-way drive system which drives the dispensing member for dispensing the line and inactivates to allow said dispensing member to be freely rotated in an opposite direction for winding in of said line, and further wherein the spool is driven by a one-way drive system which drives said spool for winding in said line but inactivates to allow said spool to be rotated for manual winding in of said line.

7. The control system of claim 6 wherein the driven dispensing member has a dispensing line speed that substantially matches or is greater than the dispensing speed of the line emanating from said spool thereby activating the one-way drive mechanism driving the spool and in turn creating line tension between the dispensing members and said spool when dispensing the line.

8. The control system of claim 5 further including a drag mechanism which is adjustable and is disposed between the spool and the drive mechanism and said drag mechanism providing at least one of:
(i) adjustable resistance to dispensing rotation of said spool by the line;
(ii) adjustable resistance to winding in of said line by said drive mechanism; and
(iii) adjustable tension of said line between said spool and the dispensing members when dispensing said line.

9. The control system of claim 1 further including a line guide controlling the position of the line emanating from the spool for the dispensing and retrieval of said line wherein said line guide is moveable and is biased against the dispensing action of said line and is associated with at least one of the dispensing members.

10. A control system for a fishing line of a fishing rod, the control system comprising
a. a reel with a spool having a fishing line,
b. at least two cooperating dispensing members arranged about the reel, for dispensing the line
c. a docking station into which the reel docks,
whereby the docking station is comprised of a support and a docking receiver on the support into which the reel docks and the reel is interchangeably attachable to both a fishing rod and said docking station.

11. The control system of claim 10 wherein when docked in the docking station the reel is powered for dispensing or winding in of the line and when said reel is not docked in said docking station said reel is not powered.

12. The control system of claim 10 wherein one dispensing member is driven and is provided on the docking station, and a second dispensing member which is not driven is provided on the reel, and the dispensing members being in cooperation when said reel is docked in said docking station.

13. The control system of claim 10 wherein the reel can rotate circumferentially about its axis while in the docking station so as to
(i) engage said reel in said docking station, or
(ii) achieve cooperation of the dispensing members, or
(iii) allow said reel to rotate to a position where said dispensing members are in a non-cooperation position, or
(iv) any combination thereof.

14. The control system of claim 10 wherein the docking station is adjustable with respect to the support so that, when in use, the angle of the reel can be adjusted in at least one of a horizontal and vertical plane including a compound angle adjustment and to allow the reel to follow the direction of pull coming from the line.

15. A control system for a fishing line of a fishing rod, the control system comprising
a. a reel with a spool having a fishing line,
b. a docking station into which the reel docks,
whereby the docking station is comprised of a support and a docking receiver on the support into which the reel docks and the reel is interchangeably attachable to both a fishing rod and said docking station.

16. The control system of claim 15 wherein there are two release mechanisms, one for releasably attaching the reel to the rod, the other for releasably attaching the reel to the docking station.

17. The control system of claim 16 further including a reel bracket with a first end for attaching to the rod and a second end for attaching to the reel, and wherein a quick-release mechanism for releasably securing said reel to said reel bracket is provided to releasably secure said reel to the second end of said reel bracket.

18. The control system of claim 17 wherein the quick release mechanism includes two cooperating portions one on the reel and the other on the reel bracket and a biased latch which automatically secures said reel to said reel bracket when said two cooperating portions are mated.

19. The control system of claim 18 wherein the biased latch is located on the reel or the reel bracket.

20. The control system of claim 16 wherein a release mechanism is located between the reel and the docking station and is characterised by two cooperating portions, one on said reel and the other on said docking station and further including a securing mechanism for securing said reel to said docking station when these two portions are mated.
